(19) United States
(12) Patent Application Publication
(10) Pub. No.: US 2014/0356744 A1
(43) Pub. Date: Dec. 4, 2014

(54) ENERGY STORAGE AND CONVERSION WITH HOT CARBON DEPOSITION

(71) Applicant: McAlister Technologies, LLC, Phoenix, AZ (US)

(72) Inventor: Roy Edward McAlister, Phoenix, AZ (US)

(73) Assignee: MCALISTER TECHNOLOGIES, LLC, Phoenix, AZ (US)

(21) Appl. No.: 14/290,911

(22) Filed: May 29, 2014

Related U.S. Application Data
(60) Provisional application No. 61/828,645, filed on May 29, 2013.

(51) Int. Cl. C01B 31/20; H01M 8/06; C01B 3/26; B01J 19/08; C01B 31/02; C01B 31/18

(52) U.S. Cl. CPC C01B 31/20; C01B 31/02; C01B 31/18; C01B 3/26; B01J 19/088; H01M 8/0618; C01B 2203/0277; C01B 2203/067; C01B 2203/06; C01B 2203/84; B01J 2219/0803; B01J 2219/0871; B01J 2219/0875
USPC 429/425; 423/445 R; 427/331; 427/402; 423/418.2; 423/437.1; 427/115; 422/186; 422/198; 422/199; 422/162; 204/173; 123/25 R; 564/63

(57) ABSTRACT

In one aspect, a method to convert a fuel into energy and specialized fuel includes, in a reactor, dissociating a fuel to produce hot carbon and hydrogen, the hot carbon having a temperature state in a range of 700 to 1500° C., in which the dissociating includes providing heat and/or electric energy to produce the hot carbon and the hydrogen; and removing the hot carbon and the hydrogen from the reactor, the removing including depositing the hot carbon to a chamber, in which the hot carbon includes an increased chemical potential energy and is capable of storing energy from an external source. In some implementations, the method can further include supplying an oxygen- and hydrogen-containing reactant to contact the hot carbon to produce carbon monoxide (CO) and hydrogen (H₂); and obtaining the produced CO and H₂, which, after the supplying, remaining deposited carbon forms a durable carbon-based good or product.

### CROSS-REFERENCE TO RELATED APPLICATION(S)

This patent document claims the benefit of priority of U.S. Provisional Patent Application No. 61/828,645, entitled “METHODS FOR ENERGY STORAGE AND CONVERSION WITH HOT CARBON DEPOSITION AND ASSOCIATED APPARATUS AND SYSTEMS” and filed on May 29, 2013. The entire content of the aforementioned patent application is incorporated by reference as part of the disclosure of this patent document.

### TECHNICAL FIELD

This patent document relates to systems, devices, and processes that use energy conversion technologies.

### BACKGROUND

Unacceptable emissions of carbon-rich particles and oxides of nitrogen are produced by a large population of internal combustion engines (ICEs), e.g., particularly including diesel engines that were manufactured and certified according to U.S. EPA Tier 2 air protection standards. For example, much of the economic capacity of the United States, which include many small businesses operated by farmers, truckers, manufacturers, and construction contractors, depend upon such engines to power a large variety of applications, e.g., including essential off-road, industrial, trucking, peak-shaving and emergency power systems, among others. Continued operation on diesel fuel prohibits utilization of such engines in many areas due to restrictions imposed by more stringent Tier 4 limitations on emissions of carbon particles and oxides of nitrogen and sulfur.

Natural gas is an attractive alternative fuel selection because it provides a higher hydrogen-to-carbon content ratio and reduces production of particulates and carbon dioxide per horsepower hour of operation. Also, natural gas is substantially less expensive per diesel gallon equivalent (DGE) in many regions, globally. However, difficult problems are presented by conventional natural gas conversion systems including reduced engine life because of lower thermal efficiency, power degradation due to compromised specific power capacity, and higher maintenance costs.

### SUMMARY

In one aspect, a method to convert a fuel into energy and specialized fuel includes, in a reactor, dissociating a fuel to produce hot carbon and hydrogen, the hot carbon having a temperature state in a range of 700° C. to 1500° C., in which the dissociating includes providing one or both of heat and electrical energy to produce the hot carbon and the hydrogen; and removing the hot carbon and the hydrogen from the reactor, the removing including depositing the hot carbon to a chamber, in which the hot carbon includes an increased chemical potential energy and is capable of storing energy from an external source. In some implementations, the method can further include supplying an oxygen- and hydrogen-containing reactant to contact the hot carbon to produce carbon monoxide (CO) and hydrogen (H₂); and obtaining the produced CO and H₂, in which, after the supplying the steam, remaining deposited carbon forms a durable carbon-based good or product.

In another aspect, a system for converting a fuel into energy or specialized fuel includes a reactor to receive a feedstock fuel and dissociate the fuel to carbon constituents and hydrogen by applying one or both of heat and electrical energy, the carbon constituents including hot carbon having a temperature state in a range of 700° C. to 1500° C. and having an increased chemical potential energy such that it is capable of storing external energy; and a chamber to receive the hot carbon, wherein the chamber is electrically or thermally insulated and structured to include a substrate where the hot carbon is deposited. In some implementations of the system, the deposited hot carbon can be reacted with an oxygen- and hydrogen-containing reactant to produce a carbon oxide and additional hydrogen. In such implementations, the system can further include an engine and/or a fuel cell to receive and utilize the produced carbon oxide and/or additional hydrogen as fuel or as reactants in reactions within the engine, and/or to extract electrical energy to produce electricity.

Those and other features are described in greater detail in the drawings, the description and the claims.

### BRIEF DESCRIPTION OF THE DRAWINGS

FIG. 1A shows a process diagram of an exemplary method for converting a feedstock into products including hot carbon used for storing energy and creating renewable fuels.

FIG. 1B shows a diagram of an exemplary system for converting a feedstock into products including hot carbon used for storing energy and creating renewable fuels.

FIG. 1C shows a schematic diagram of an exemplary embodiment of a system for energy conversion and storage in an engine.

FIG. 1D shows a schematic diagram of another exemplary embodiment of a system for energy conversion and storage in an engine.

FIG. 2A shows a diagram of an exemplary system of the disclosed technology for production of hot carbon and hydrogen using engine exhaust heat for heating feedstock fuel in addition to fuel cell applications.

FIG. 2B shows a diagram of an exemplary accumulator assembly.

FIG. 2C shows a diagram of another exemplary system of the disclosed technology for production of hot carbon and hydrogen and implementations in fuel cell applications.

FIG. 2D shows a cross-sectional view of the exemplary system of FIG. 2C depicting multiple canisters for facilitating reactions.

FIG. 3 shows a diagram of an exemplary system of the disclosed technology that can be used for deposition of hot carbon and production of pressurized or non-pressurized hydrogen as well as in hot carbon fuel cell applications.

FIG. 4 shows a diagram depicting an exemplary implementation of hydrogen production from hot carbon by reaction with steam in an exemplary system of the disclosed technology.

FIG. 5A shows a schematic diagram of an engine employing an exemplary system of the disclosed technology for energy conversion and production of specialized fuels.

FIG. 5B shows a schematic diagram of an exemplary injector device that can be implemented in exemplary systems of the disclosed technology, including the system of FIG. 5A.

FIG. 5C shows a cross-sectional view of the exemplary device of FIG. 5B.

FIG. 5D shows an enlarged view an end of the device in FIG. 5B showing an optical sensor unit.

FIG. 6 shows a diagram depicting fuel conditioning events of an exemplary system of the present technology utilizing heat sources to convert various gases, mixed-phase fluids, and/or liquid fuel selections into pressurized fuel vapor and then to dissociate into constituents.

Like reference symbols and designations in the various drawings may indicate like elements.

### DETAILED DESCRIPTION

Techniques, systems, and devices are disclosed for converting fossil fuel and/or renewable fuel selections into energy and/or specialized fuels such as hydrogen that can be utilized in engines and/or fuel cell applications.

In some aspects, a method to convert such fuel feedstocks into energy and specialized fuels includes dissociating a fuel to produce hot carbon and hydrogen, e.g., in a reactor. Hot carbon includes carbon material at an elevated temperature state, e.g., in a range of 700° C. to 1500° C., and/or at an elevated temperature approaching visible light emitting or incandescent temperatures. The produced hot carbon is of a material form having an increased chemical and/or thermal potential energy and is capable of storing energy from an external source (e.g., heat). The hot carbon can be produced by endothermic dissociation of a carbon and/or hydrogen donor substance (e.g., CₓH_{y}), in which the dissociating includes providing heat and/or electric current (e.g., electrons) to produce the carbon and the hydrogen. The method includes removing the produced hydrogen and hot carbon from the reactor, e.g., by depositing the hot carbon in a chamber. In some implementations, the method further includes supplying an oxygen- and/or hydrogen-containing reactant (e.g., such as oxygen, steam, alcohol, or air) to contact the hot carbon to exothermically produce products such as carbon monoxide (CO) and hydrogen (H₂), in which, after the supplying the reactant, remaining deposited carbon forms a durable carbon-based good or product.

In some implementations of the method, for example, in the reactor, one or more electrodes are electrified with the electrical energy that provide electrons and/or generate heat to dissociate the fuel (e.g., CH₄) into carbon and hydrogen. For example, the dissociating can include endothermic conversion of the fuel (e.g., CₓH_{y}) to the hot carbon (xC) and hydrogen (H₂), where CₓH_{y}+Energy (e.g., thermal and/or electrical energy at the electrodes that generate heat)→xC+0.5y H₂ can occur at or near the electrode(s). For example, the electrode(s) can be configured as a suitable metallic alloy, graphite, silicon carbide or molybdenum disilicide electrode, and/or a composite electrode assembly described later in this patent document. In some implementations, for example, the produced hydrogen can be fed to a pressurizer (e.g., galvanic cell with a proton membrane) that pressurizes the hydrogen for use, for example, in fuel cell or an engine. In some examples, ship vessels could use electricity from their electrical generators or from ports to power this dissociation step.

In implementations of the method, for example, the carbon can be removed from the fuel by an endothermic precipitation process. For example, the deposited hot carbon can be used to store energy from regenerative processes, e.g., such as regenerative braking or shock absorbers in vehicle applications. Furthermore, electricity from regenerative processes can be used to drive the dissociating (e.g., in the reactor of the system to implement the method). In some implementations, for example, hot carbon is deposited in the chamber on a substrate, and/or in which the chamber is electrically and/or thermally insulated. Exemplary substrates can include, but are not limited to, graphene, nickel, mica, silicon carbide, ceramic, or carbon with a SiN and/or BN coating, among others.

For example, the deposited or banked hot carbon can be formed as amorphous carbon (e.g., hot carbon depositions) in the chamber, which provides dense thermal storage capability. In the chamber, for example, the hot banked carbon can be formed on a suitable surface, e.g., such as a scored glass ceramic or vitreous carbon. The hot banked carbon can be readily utilized in the chamber and/or continuously or intermittently (e.g., at desired occasions) removed to a suitable location to provide thermal and chemical banking of external energy or substances, respectively. For example, thermal or electrical energy banking to the hot banked carbon can provide better energy storage efficiency than a battery, as well as be substantially more inexpensive (e.g., without need for additional and costly materials). For example, energy conversion cycle efficiency of the created hot banked carbon can be ˜50%, as compared to that of battery of less than 12%.

In some implementations, the fuel-to-energy conversion method can be implemented to additionally, or alternatively, create hot banked nitrogen as a material for banking energy and providing capability to produce subsequent products. For example, nitrogen can be taken from the air or from nitrogen rich exhaust and combined with hydrogen to make ammonia or urea. In such implementations, the banking comes from the formation of a compound (e.g., ammonia or urea). For example, pressurized hydrogen and nitrogen are used to form ammonia and/or urea.

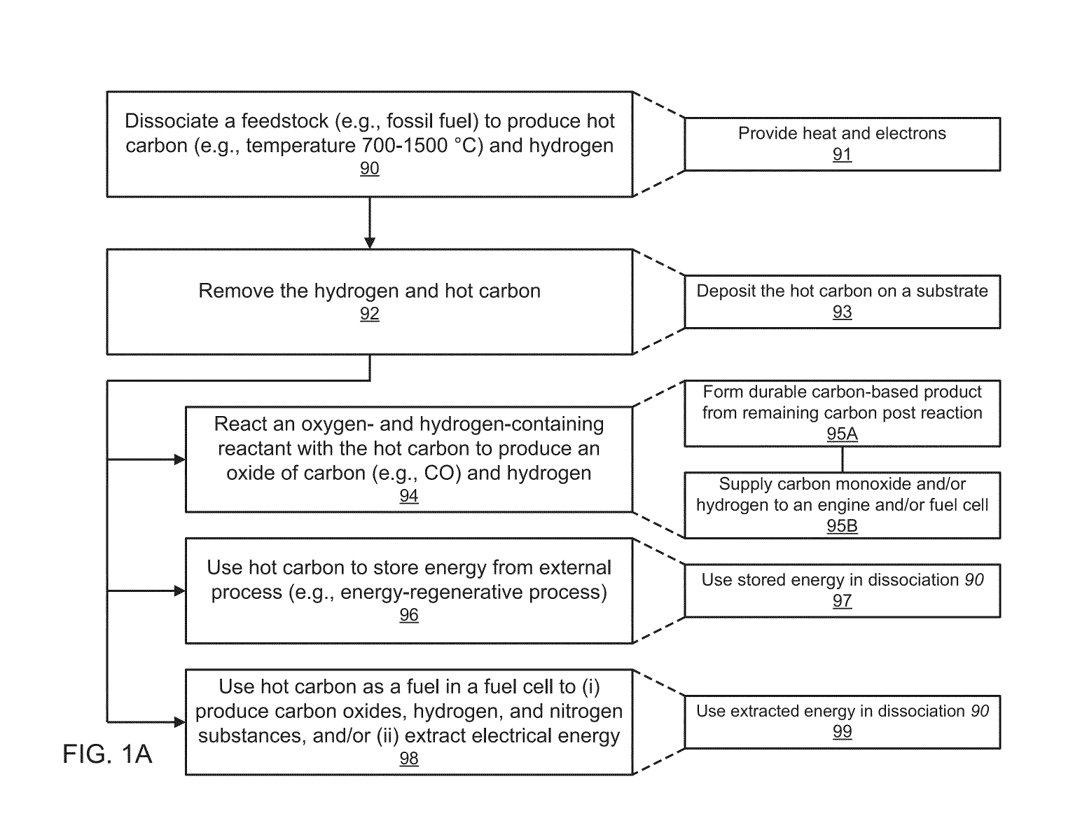

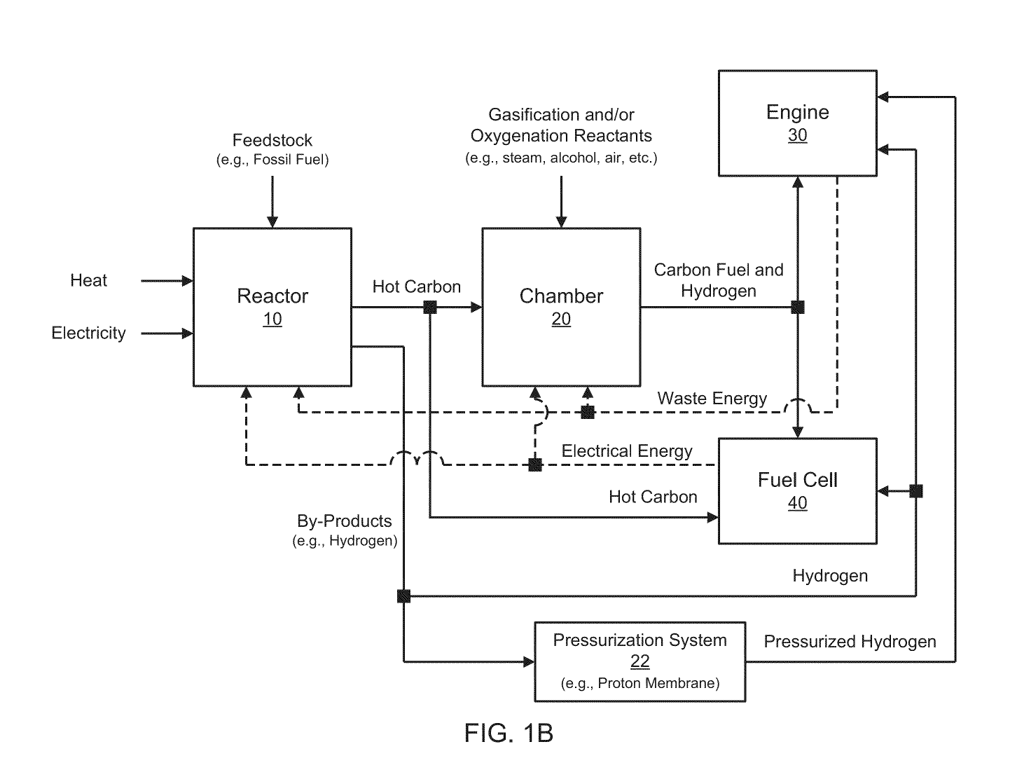

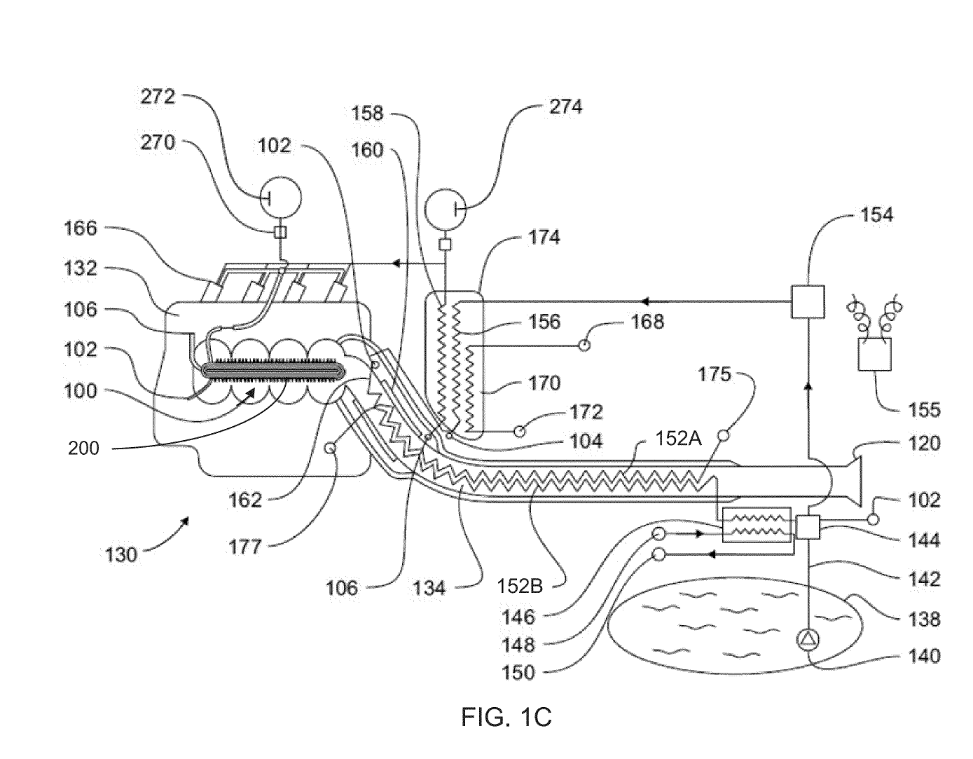

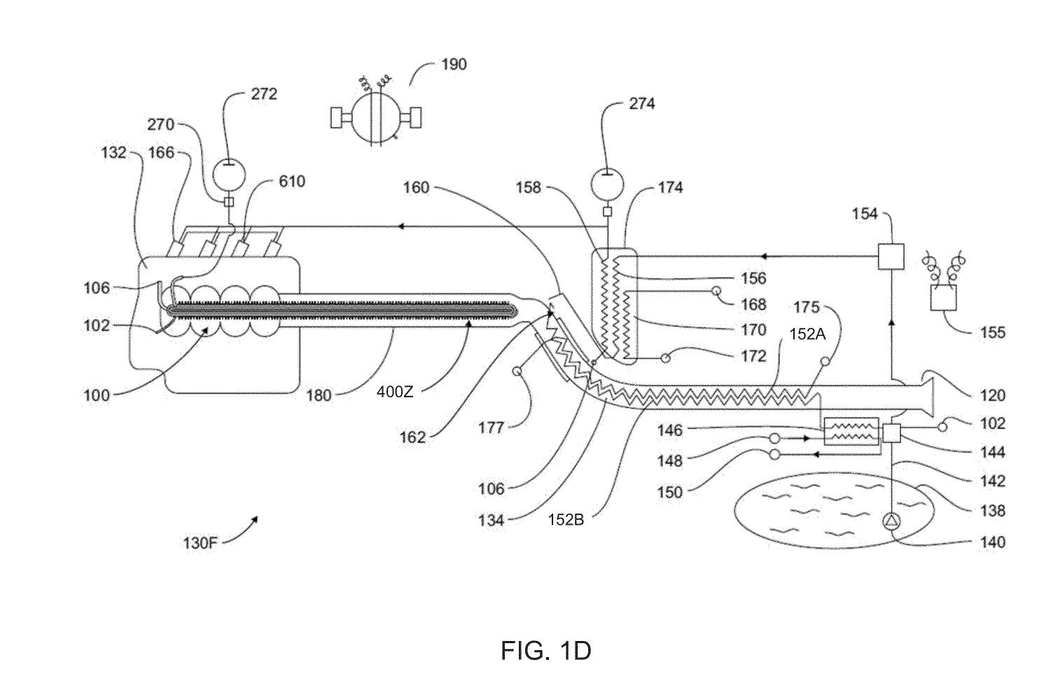

FIG. 1A shows a process diagram of an exemplary method for converting a feedstock, e.g., such as CₓH_{y}, into specialized products including hot carbon used for storing energy and/or creating renewable fuels. The method can include a process 90 to dissociate the feedstock to produce hot carbon (e.g., having a temperature of 700° C. to 1500° C.) and hydrogen, e.g., which can be implemented in a reactor. In some implementations of the process 90, the dissociating can include a process 91 to provide heat and/or electrons to produce the hot carbon from the dissociated products of the feedstock. The method can include a process 92 to remove the hot carbon and the hydrogen. In some implementations of the process 92 can include a process 93 to deposit the hot carbon on a substrate or surface, e.g., in a chamber (e.g., including an accumulator).

The method shown in FIG. 1A can further include a process 94 to react an oxygen- and hydrogen-containing reactant with the hot carbon to produce an oxide of carbon (e.g., carbon monoxide) and hydrogen. In some implementations of the process 94, the reacting can include a process 95A to form a durable carbon-based product from the remaining carbon after implementation of the process 94; and/or, the reacting can include a process 95B to supply the produced carbon monoxide and/or the produced hydrogen to an engine and/or to a fuel cell.

The method shown in FIG. 1A can further include a process 96 to use the hot carbon to store energy from an external process (e.g., such as an energy-regenerative process). In some implementations of the process 96, the energy stored by the hot carbon can be used in the process 90 to dissociate the feedstock.

The method shown in FIG. 1A can further include a process 98 to use the hot carbon in a fuel cell to (i) produce carbon oxide(s), hydrogen, and/or nitrogen substances, and/or to (ii) extract electrical energy from the hot carbon, which can be used in other processes of the method. In some implementations of the process 98, the electrical energy extracted by the hot carbon can be used in the process 90 to dissociate the feedstock.

FIG. 1B shows a diagram of a system capable of implementing the method of FIG. 1A for converting a feedstock into specialized products including hot carbon and by-products including hydrogen. In one exemplary embodiment, the system includes a reactor 10 to receive the feedstock substance (e.g., a carbon- and/or hydrogen-donor substance such as a fossil fuel or renewable fuel including methane) and dissociate the feedstock substance to carbon constituents and hydrogen. The reactor 10 is used to produce hot carbon by applying heat and/or electrons during the dissociation of the feedstock, such that the hot carbon produced is a specialized form of carbon having an increased chemical potential energy and is capable of storing external energy when applied to the hot carbon. The system includes a chamber 20 where the hot carbon can be deposited. In some embodiments, for example, the chamber 20 is electrically and/or thermally insulated and includes a substrate to deposit the hot carbon. For example, the substrate can include, but is not limited to, graphene, nickel, mica, silicon carbide, molybdenum disilicide, ceramic, or carbon with a SiN and/or BN coating, among other materials.

In some implementations of the system, the deposited hot carbon in the chamber 20 can be reacted with gasification and/or oxygenation reactants (e.g., such as steam, alcohol, air, etc.) to produce a carbon-containing fuel and hydrogen. In such implementations, for example, the system can further include an engine 30 to receive and utilize the produced carbon-containing fuel and/or the produced hydrogen as fuel or other reactants in reactions within the engine 30 (e.g., including combustion). Additionally, for example, the hydrogen produced by the reactor 10 can also be supplied to the engine 30 in such reactions (e.g., combustion). Moreover, for example, the hydrogen produced by the reactor 10 can be pressurized by a pressurization system 22 to supply pressurized hydrogen to the engine 30. The engine 30 may produce waste heat as part of reactions implemented in the engine 30. Such waste heat may be included in the system and supplied to the chamber 20 and/or the reactor 10 to assist in reactions (e.g., such as the dissociation of the feedstock in the reactor 10 to produce the hot carbon banked in the chamber 20).

Also, in such implementations, for example, the system can further include a fuel cell 40 to receive and utilize the produced carbon-containing fuel and/or the produced hydrogen as the fuel or other reactants in the fuel cell 40 to extract electrical energy. Such electrical energy, as well as electrical charge carriers (e.g., electrons) may be included in the system and supplied to the chamber 20 and/or the reactor 10 to assist in reactions (e.g., such as the dissociation of the feedstock in the reactor 10 to produce the hot carbon banked in the chamber 20). Additionally, for example, the hydrogen produced by the reactor 10 can also be supplied to the fuel cell 40 for use in fuel cell reactions. Furthermore, for example, the hydrogen produced by the reactor 10 can also be pressurized by the pressurization system 22 to supply pressurized hydrogen to the fuel cell 40.

Some applications of the disclosed methods and systems can include the following examples. In some examples of the disclosed technology, an engine conversion system of the disclosed technology produces hydrogen from fossil fuel selections such as natural gas and various renewable fuels using the disclosed methods, in which the hydrogen can subsequently be directly injected in one or more bursts and combusted to provide stratified heat release within the combustion chambers of converted engines. In certain embodiments the combustion regime incorporates expansive Joule-Thomson (J-T) heating of pressurized hydrogen or elevated temperature, high-pressure hydrogen that is injected at or after top dead center (TDC) to further increase the rate of oxidation to expedite initiation and completion of combustion of other fuel constituents including homogeneous and/or stratified charge fuel distributions.

For example, converted engines previously operated on diesel fuel according to Tier 2 emissions standards can utilize the hydrogen-characterized or hydrogen-boosted combustion regime to produce more power, last longer, and meet and/or exceed more stringent emissions requirements such as Tier 4 emissions standards. Sequential operations of the method in the exemplary engine conversion system can produce additional hydrogen (e.g., by hydrocarbon dissociation) and provide hot banked carbon (HBC) to produce enhanced expendable energy, e.g., including heat, pressure, and/or chemical potential energy. For example, the co-produced hydrogen can be used to provide cold-engine start-ups and/or acceleration without particulates or other objectionable emissions throughout all modes of engine operation. In some implementations of the system, the hot banked carbon can be obtained from the chamber and utilized as a fuel in, for example, high temperature fuel cell production of electricity. Additionally or alternatively, the hot banked carbon can be converted by gasification and oxygenation reactions with oxygen donors, e.g., such as steam, alcohols, air, and/or oxygen, to continue hydrogen production for improved engine efficiency with accelerated completion of combustion without objectionable emissions. Engine waste heat collected from coolant (H-1) and exhaust gases (H-2) provide endothermic energy for production of hydrogen and/or to gasify and oxygenate hot banked carbon as it is prepared for clean combustion and/or fuel cell operations.

The converted engines can achieve very clean cold starts and operations that achieve Tier 4 emissions requirements by operation on hydrogen according to a combustion management system that reduces or prevents emissions of oxides of nitrogen. In implementations, for example, after the engine's operating temperature is reached, subsequent operation provides utilization of H-1, H-2 and/or regenerative heat H-3 for the reaction of steam and hot-banked carbon that produces hydrogen and carbon monoxide that fuel the engine, e.g., according to electronic control and injection embodiments to accomplish Tier 4 requirements, improve fuel efficiency, and produce full rated power when needed.

Further hybrid improvements are provided by operation of fuel cells that utilize carbon, carbon monoxide, and/or hydrogen for direct production of electricity without limitations imposed by heat engine-alternator-inverter-battery efficiency for electric energy generation for high fuel cell efficiency at widely varying engine speed and load variations, for example. Carbon can be banked during times that H-1, H-2 and/or H-3 may be available for subsequent use such including later times by a fuel cell to silently produce electricity. Reversible fuel cell electric drives for hybridized driveline combinations (with the combustion engine) along with air-conditioning and power accessories such as windshield wipers, seats, entertainment devices allow regenerative deceleration and shock absorbing for additional improvements in system efficiency.

### Exemplary Embodiments

Further embodiments of the systems shown in FIG. 1A that can implement the methods shown in FIG. 1B are described in the following examples.

FIG. 1C shows a schematic diagram of an exemplary system 130 for energy conversion and storage in an engine 132. As shown by the exemplary embodiment in FIG. 1C, the system 130 can receive the selected fossil fuel from a storage tank 138 capable of storing compressed natural gas, hydrogen, and/or carbon donor fuel selections. In some embodiments, for example, the storage tank 138 can be configured as one or more suitably insulated and/or reinforced storage systems. For example, such carbon donor fuel selections can include, but are not limited to, methane or methanol, and/or self-pressurizing cryogenic fuels such as methane or slush mixtures of hydrogen and methane and/or ethane or propane, or various ambient temperature liquid fuels such as alcohols, ammonia, various urea solutions, dimethylether (DME) or diethylether (DEE).

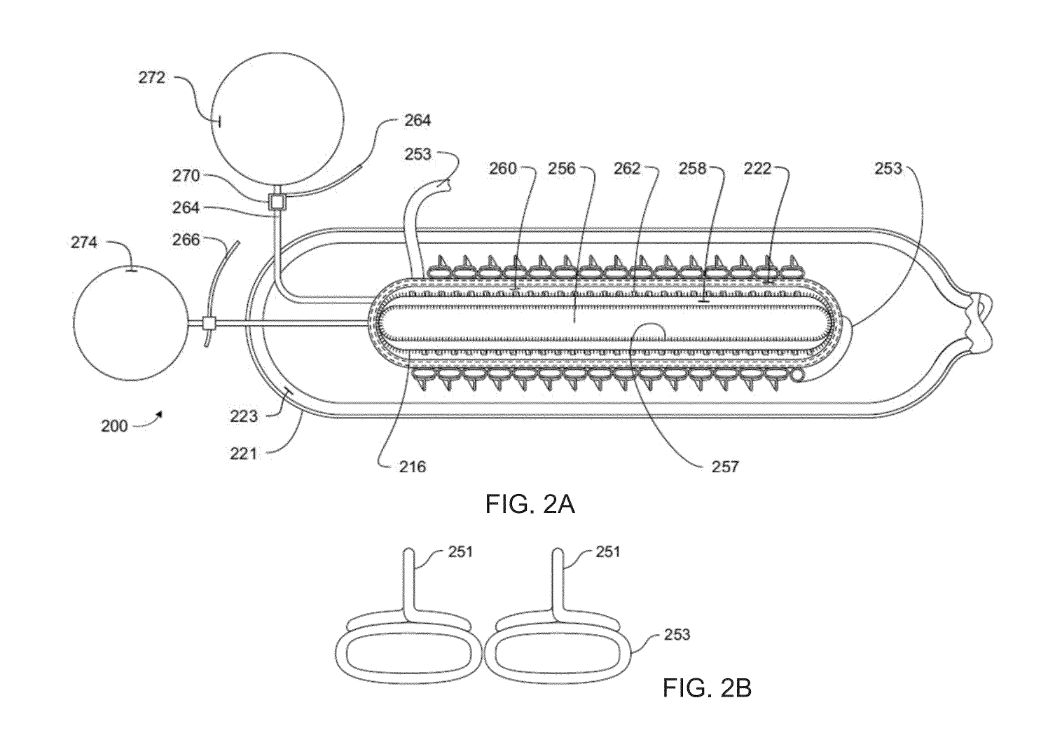

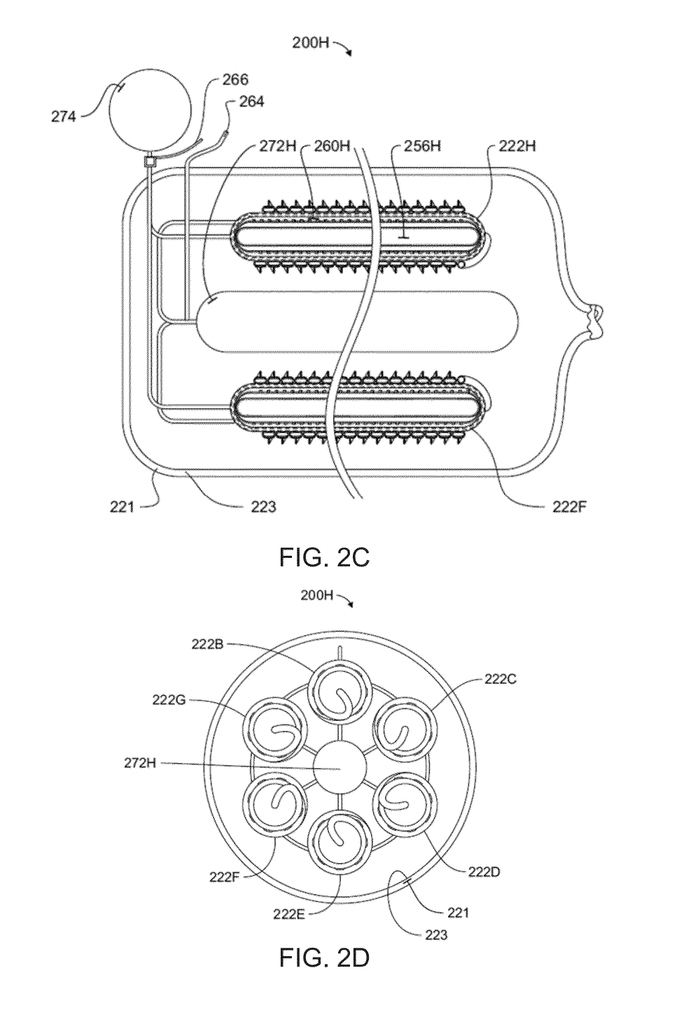

At start up and various other occasions, a suitable flow of the selected fossil fuel (e.g., such as a hydrocarbon type fuel including natural gas, methane, or other) can be directly delivered from the tank 138 via fluid transport line 142 by intaking the fuel using pump 140 to an engine exhaust manifold reactor 100 via to port 102 by control of valve 144. The engine exhaust manifold assembly 100 provides a fail-safe containment including pressure blow-down and cooling by the exhaust system 120. The engine exhaust manifold assembly 100 can host or be operated as a reactor of the system 130 to provide heating of the feedstock fuel, e.g., by gaining heat from hot exhaust gases and/or other sources, via an engine exhaust heated and insulated circuit of a system 200. An exemplary embodiment of the system 200 is shown in greater detail in FIG. 2A.

The system 130 shown in FIG. 1C can also include other components including heat exchange assemblies 146, 174 and others and a controller 155 to actuate various functions of components in the system 130. For example, the controller 155 can provide adaptive operation of the pump 140 and/or the valve 144 to add fuel from the tank 138 to a heat exchanger 146 to gain heat (e.g., Heat₁ (H1)) from engine coolant passing through transports 148 to 150, e.g., capable of reaching temperatures such as 102° C. (215° F.). Also, for example, the controller 155 can also provide adaptive operation of a valve 154 to add fuel to a heat exchanger 174 to receive heat (e.g., H1) by counter current heat exchange from engine coolant passing through transports 168 to 172 and/or by counter current passage of the fuel through heat exchange circuit 156. The system 130 can utilize and/or include injectors 166 to inject the fuel into a combustion chamber of the engine 132.

Referring to FIG. 2A, a feedstock fuel (e.g., such as methane) is delivered to accumulator cavity 256, e.g., supplied through a conduit 253 of heat transfer passageway assembly 251-253 as shown in FIG. 2B, in which the accumulator 256 is within a tubular composite assembly including a porous anode 257 surrounding the accumulator 256, a proton transport membrane 258, and a hydrogen-transmissive or permeable cathode 216. For example, inductive and/or resistive heating of the composite assembly (the anode 257—membrane 258—cathode 216) can be applied by a suitable arrangements and configurations, e.g., such as a screen grid or helical coil 262, to increase the temperature for endothermic heat additions for processes such as shown in Equations 1 and 2. Also, for example, increasing the temperature by electric heating or fuel combustion (e.g., H₄ and/or H₅) can provide higher reaction rates and/or shift such reactions for increasing the yield of products including increased pressurization of the reaction products. In some implementations, for example, further improvements of reaction rates and yields along with higher pressure delivery of hydrogen into the annular accumulator around cathode 216 can be provided by increasing rate that hydrogen is removed from the products by increasing the voltage gradient from the anode 257 to the cathode 216.

In this and several other examples, an accumulator of the disclosed systems can operate as a chamber for deposition of materials, e.g., including deposition of hot carbon, and/or for facilitating reactions (e.g., a reactor), e.g., including dissociating a fuel into the hot carbon and by-products (e.g., hydrogen).

FIG. 2B shows a diagram of an exemplary accumulator assembly having a helical heat exchanger tube 251-253 coupled to the main body of the accumulator tube 222 where 221 insulates the exhaust manifold 223 within which is the heat exchanger assembly 251-253 around a container tube 222 that delivers separated and/or galvanically pressurized hydrogen to conduit 264 through valve 264 to accumulator 272 and or conduit 264 as shown. Such hydrogen is produced by suitable reaction such as by dissociation of a carbon and/or hydrogen donor substance such as CₓH_{y}, e.g., an alcohol, or ether, etc., which can be delivered through conduit 104 or 253 from the tank 138 and/or by preheating through heat exchangers such as 146 and/or 134 (e.g., using the circuit 152B).

Equation 1 shows production of hydrogen and carbon (e.g., which can be produced as hot carbon) from virtually any carbon donor fuel C_{y}H_{z}.

C_{y}H_{z}+Heat₁→yC+0.5zH₂ Equation 1

Equation 2 shows production of the carbon and hydrogen from CH₄ hydrocarbon fuel selections, e.g., such as natural gas or renewable methane.

CH₄+Heat₂→C+2H₂ Equation 2

Endothermic Heat₂ required for the process of Equation 2 is about 75 KJ/mol or less depending upon the amount of regenerative preheat and the temperature of electrode 257. In this mode, the carbon is deposited or “hot banked” within the accumulator 256 of the system 200 as the engine 132 is operated, e.g., on stratified heat production by direct high pressure hydrogen injection to produce expansive heating and accelerated combustion after TDC for improved performance and greater thermal efficiency along with achieving Tier 4 emissions compliance without requiring exhaust gas treatment.

It is particularly noteworthy that the present exemplary embodiments described here can provide for engine operations that produce hydrogen and perform adaptive stratified charge combustion to effectively clean the air that enters converted engines. In operation, for example, ambient air that contains atmospheric contaminants such as diesel soot, tire particles, pollen, paint fumes, mildew or ammonia odors, various volatile hydrocarbons and constituents of photo-activated smog is compressed during the compression cycle of ICE operation and before, at or after top dead center (TDC) hydrogen is injected and combusted to provide stratified charge air cleansing.

Additionally, hot hydrogen injection after TDC increases the benefits provided by J-T expansive heating including reduced requirements for ignition energy, reduced electrode erosion, accelerated initiation and completion of combustion along with contaminant eradication. Further synergistic benefits can be provided by a corona discharge into the pattern of hydrogen ions and molecules and/or hot products of combustion. Initiation of corona discharge into the pattern of J-T expansion heated hydrogen and/or hydrogen ions greatly improve corona ignition efficiency. The host engine is thus greatly improved in thermal efficiency including improvements in the air-utilization efficiency to assure rapid and complete oxidation of the fuel, insulation of the stratified heat of combustion, and expansion of heated air to perform work along with enabling air cleansing benefits.

Examples of methods to produce such patterned corona discharges are described in U.S. patent application Ser. No. 13/844,488 entitled “FUEL INJECTION SYSTEMS WITH ENHANCED CORONA BURST”, and in U.S. patent application Ser. No. 14/273,479 entitled “FUEL INJECTION SYSTEMS WITH ENHANCED CORONA BURST”, both of which are incorporated by reference in their entirety as part of the disclosure of this patent document.

Stratified charge combustion of hydrogen provides extremely rapid reduction or elimination of such contaminants by forcing oxidation to produce water vapor and traces of carbon dioxide. For example, if ozone and/or oxides of nitrogen are present in ambient air, hydrogen combustion consumes such activated oxidants to expedite production of water vapor. Contaminants oxidized in surplus air to water vapor and/or carbon dioxide upon hydrogen accelerated combustion in surplus air can provide 20 to 10,000 times reduced trapping of solar radiation energy compared to contaminants such as volatile hydrocarbons, paint fumes, and diesel soot.

Subsequently, after sufficient hot carbon is deposited or banked within the accumulator 256 by the processes of Equations 1 or 2 to allow clean startup of the host engine 232, selected portions of the hot banked carbon can be utilized in a fuel cell and/or extracted from the accumulator 256 to produce carbon enhanced durable goods, and/or such carbon can be reacted with suitably heated steam to produce a mixture of carbon monoxide and hydrogen as shown in Equation 3 for use in a heat engine and/or fuel cells and/or to produce liquid fuels, e.g., such as various fuel alcohols, DME, or DEE.

C+H₂O+Heat₃→CO+H₂ Equation 3

The systems of FIG. 1C can allow for regenerative operations. For example, the endothermic heat requirement or Heat₃ of Equation 3 can be delivered by the hot carbon deposited by reactions of Equations 1 or 2, and/or by the steam previously heated as a result of energy added by hot exhaust gases, resistor or inductor (e.g., screen grid or helical coil 262), heat added to the membrane 258 by electrical resistance, heat exchanger assembly 251-253, and/or by heat gained such as from the countercurrent heat exchanges within the heat exchanger 146, the exhaust system 120 (e.g., as shown including circuits 152A and 152B), and/or the system 200 with exhaust gases and/or engine coolant and/or by heat gained by countercurrent exchange from one or both products of the reaction summarized by Equation 3.

Additionally or alternatively, in certain embodiments, for example, oxygen provided by sources such as electrolysis of water, steam, and/or by extraction of oxygen from the atmosphere is reacted with such carbon to produce carbon monoxide in an exothermic reaction as shown in Equation 4. Such optional operation by partial oxidation of carbon as shown in Equation 4 is exothermic.

C+0.5O₂→CO+Heat₄ Equation 4

Exothermic Heat₄ is about −111 KJ/mol and can be utilized as a heat source or as a supplement to Heat₃. This exemplary mode of heating is highly beneficial in instances that a limited amount of electrical energy is available from sources such as a storage battery to produce Heat₃ at the rate desired for quick start-up of a fuel cell or cold engine and rapid warm-up operations in cold ambient conditions.

In another optional mode, for example, greater heat release and more rapid conversion of one or more selected allotropes of hot banked carbon is summarized by Equation 5.

C+O₂→CO₂+Heat₅ Equation 5

Exothermic Heat₅ is about −283 KJ/mol and can be utilized as a greater heat source or supplement to Heat₁ or Heat₃. Hot oxides of carbon produced by reactions of Equations 4 and/or 5 provide heating such as counter current heating of feedstock fuel and reactants in a heat exchanger 170 through ports 168 and 172.

Thus several modes of operation may be selected including various simultaneous, sequential, or cyclic operations, e.g., such as fuel cell and engine operations that combine endothermic and exothermic heat contributions of reactions such as in Equations 1, 3 and/or 5. This can provide assurance of meeting Tier 4 emissions requirements with cold start and every other operational condition.

Operational modes of the disclosed systems can be implemented, illustratively, in fuel cell and engine embodiments, such as in the following examples. For example, (i) some system operational modes include endothermic conversion by dissociation at an elevated temperature typically between 700° C. and 1500° C. of a hydrocarbon compound (CₓH_{y}) to produce hydrogen and xC hot banked carbon (e.g., CₓH_{y}+Heat→xC+0.5y H₂) on or near the anode of an exemplary composite assembly including an anode, proton transport membrane, and a cathode. Also for example, (ii) some system operational modes include separation and/or pressure addition to the hydrogen (to form pressurized hydrogen) produced and delivered by ionic membrane transport through an applied voltage gradient between the anode and cathode. Also for example, (iii) some system operational modes include direct injection of such pressurized hydrogen at or after TDC to generate J-T expansive heating and accelerated combustion within surplus air in the combustion chamber of an engine to produce stratified heat release and high thermal efficiency along with clean emissions. Also for example, (iv) some system operational modes include occasionally converting the hot banked carbon by elevated temperature reaction with an oxygen donor such as air, oxygen or steam (e.g., C+H₂O+HEAT→CO+H₂) to provide gasification and oxygenation of the carbon to carbon monoxide and to produce additional hydrogen that is separated and can be increased in pressure by transport through the proton membrane by impetus of an applied voltage gradient between the anode and cathode. Also for example, (v) some system operational modes include delivery to the combustion chamber of the gasified and oxygenated carbon (e.g., carbon monoxide) and direct injection of such pressurized hydrogen at or after TDC to generate J-T expansive heating and accelerated combustion within surplus air in the combustion chamber of an engine to produce stratified heat release and high thermal efficiency along with accelerated combustion of such carbon monoxide to produce clean emissions. Also for example, (vi) some system operational modes include conversion of the hydrocarbon fuel to carbon monoxide and hydrogen (CₓH_{y}+xH₂O+HEAT→xCO+(0.5y+x)H₂), whereby the hydrogen is pressurized by the heat added to drive such phase change and/or molecular increasing reactions and separated by pressure drop and/or pressure increasing transport through the proton membrane including pressure produced by such reactions and/or by an applied voltage gradient between the anode and cathode. Also for example, (vii) some system operational modes include delivery to the combustion chamber of the gasified and oxygenated carbon (e.g., carbon monoxide) as a stratified or homogeneous charge and direct injection of such pressurized hydrogen at or after TDC to generate J-T expansive heating and accelerated combustion within surplus air in the combustion chamber of an engine to produce stratified heat release and high thermal efficiency along with accelerated combustion of such carbon monoxide to produce clean emissions.

Variations of these and other exemplary operational modes of the disclosed systems can include utilization of some of the hot banked carbon (HBC) to produce carbon monoxide and/or carbon dioxide to generate at least a portion of the heat added to other endothermic steps at times that more rapid reaction rates are desired. For example, ordinarily, activated carbon is produced by heating a carbon donor to drive off hydrogen and produce high surface to volume media for adsorbing fluids such as gases and liquids. An exemplary embodiment of the disclosed systems that produce hot banked carbon system deposits the hot banked carbon in particular locations, e.g., such as on or near the anode 257 and/or within the accumulator 256 as shown in FIG. 2A, for very different additional purposes including, for example, performance as a heat retaining energy storage media that facilitates rapid addition of carbon deposits from a hydrocarbon donor; rapid contribution of hot carbon to form carbon monoxide by reaction with hot steam and/or alcohol, oxygen, or air; and/or to serve as a hot fuel accelerator in carbon and/or carbon monoxide fuel cell processes to produce electricity much more efficiently than a heat engine-generator system.

In some implementations of the disclosed systems, the rapid deposition of carbon from high pressure gases (feedstocks), e.g., such as methane or larger molecular weight selections, can provide highly activated carbon deposits with high surface-to-volume ratios, e.g., in which the depositions can be implemented on nano-particles of silicon, cobalt, gold, nickel, or platinum to stimulate growth of single or multi-atom thick wall tubes or to provide variously disorganized forms of carbon including amorphous or curvilinear or multi-dimensional graphene for the purpose of high removal rate for gasification production of oxygenated carbon such as carbon monoxide and/or to serve as carbon fuel in a fuel process.

In some implementations, the deposition of carbon can be utilized in fuel cell applications. Voltage applied across the cathode 216 through the proton exchange membrane 258 to the anode 257 provides a galvanic gradient along with resistance heating. In some embodiments, for example, the cathode 257 can include multiple and/or heterogeneous catalysts for one or more functional roles.

In some implementations, catalytic activity can be provided for nucleation and growth of selected allotropes of carbon that deposit as hydrogen passes into the proton exchange membrane 258 for delivery to the cathode 216. For example, amorphous or glassy carbon or various other forms can be grown, e.g., such as Fullerenes, graphene, graphite, diamond, diamond-like-carbon, aggregated nanorods and shapes, whisker and/or tubular forms, which can be initiated by catalysts, e.g., such as carbon nanotubes, carbon nanofoam, nickel, iron, tungsten, molybdenum, niobium, vanadium, copper or copper based alloys, intermetallics, carbides, nitrides, or cermet compounds.

As shown in FIG. 2A, galvanically separated and accelerated pressurized delivery of hydrogen through cathode 216 to concentric accumulator space 260 can be implemented and can accomplish any of the following. For example, (i) heat provided for endothermic hydrocarbon dissociation at or on the anode 257 by the heating element 262 (e.g., inductive and/or resistive element 262) can be conserved and insulated by the concentric assembly of a high-strength canister 222, gaseous hydrogen in the annular accumulator 260, and the membrane 258. Also, for example, (ii) the hydrocarbon dissociation reaction summarized in Equations 1 and/or 2 can be shifted to improve the process yield efficiency by prompt removal of hydrogen from the feedstock reactant and product inventory. Also, for example, (iii) hydrogen pressurized by the galvanic impetus applied across the electrodes 216 and 257 provides advantageous compressive loading of membrane 258 to assure structural integrity, crack prevention, and improved fatigue endurance against vibration, thermal and pressure cycling to allow rapid startup and extended life. Also, for example, (iv) hydrogen produced by the galvanic impetus across the proton exchange membrane 258 can be pressurized to aid in production of brake mean effective pressure (BMEP) upon direct injection at desired crank angles including at or after TDC into each of the combustion chambers of the exemplary engine 132 (e.g., through injectors 166) as shown in FIG. 1C. Also, for example (v) hot pressurized hydrogen can be further heated by Joule-Thomson expansive heating as it is injected at or after top dead center (TDC) and expands into each combustion chamber to further aid in production of BMEP and to accelerate the initiation and completion of hydrogen combustion. Also, for example, (vi) such types of hydrogen activation can accelerated combustion of other fuel constituents present, e.g., including airborne contaminants in the combustion chamber. Also, for example, (vii) feedstock hydrogen-donor gases, e.g., such as methane, processed by the accumulator 256 can be conveyed from the port 106 to the heat exchanger 174 (in the system 130 of FIG. 1C) to preheat hydrocarbon substances such as by the counter current heat exchanger 156 via the port 104. Also, for example, (viii) reduction of the work of compression and further improvement in BMEP can be provided by direct injection before TDC of expansive cooling fluid from the tank 138 and/or the accumulator 256 and/or from the heat exchanger 174 and/or from an accumulator 274 of the system 200, shown in FIG. 2A.

Referring to FIG. 1C showing the exemplary system 130, after reaching operating temperature, the controller 155 can be implemented to provide adaptive operation of the pump 140 and/or the valves 144 and 154 to add fuel from the tank 138 to the heat exchanger 146 to gain H1 from engine coolant in circuits 148-150 and reach temperatures (e.g., such as 102° C. (215° F.)) and/or through heat exchanger 174 to receive H1 by counter current heat exchange from engine coolant passing from port 168 to 172 and/or by counter current passage of fuel from tank 138 through circuit 156. After gaining H1, fuel is circuited through the exhaust train counter current heating circuit 152A and/or 152B to receive H2, and then to the accumulator 256 for further electric or fuel combustion heating and the anode 257 of the system 200 to provide hydrogen that is further galvanically pressurized, delivered through insulated circuit 264 and/or accumulator 272 for adaptively timed injection by the injectors 166 as a hot expansion heating fuel at or after TDC in the combustion chambers of engine 132.

In some implementations, for example, including at selected times and in various applications such as quick start for maintaining an uninterruptable power supply (UPS) or operation of a vehicle or a combined heat and power (CHP) plant without emissions of undesirable pollutants, the engine 132 can be operated on hydrogen. Illustratively, at times such as cold engine start up, hydrogen is delivered from the accumulator 260 or as may be provided from previous system operations by the accumulator 272 and/or by initial heating and/or processing by the system 200 of a suitable hydrogen donor fuel, e.g., such as methane, using off peak grid power. Suitable heat addition may be made from renewable sources such as a solar, wind or moving water generator, or other sources of electricity such as from a battery or by grid power applications, e.g., including maintenance of a suitable UPS start up supply of hydrogen in the accumulator 260 and/or the accumulator 272 through valve 270.

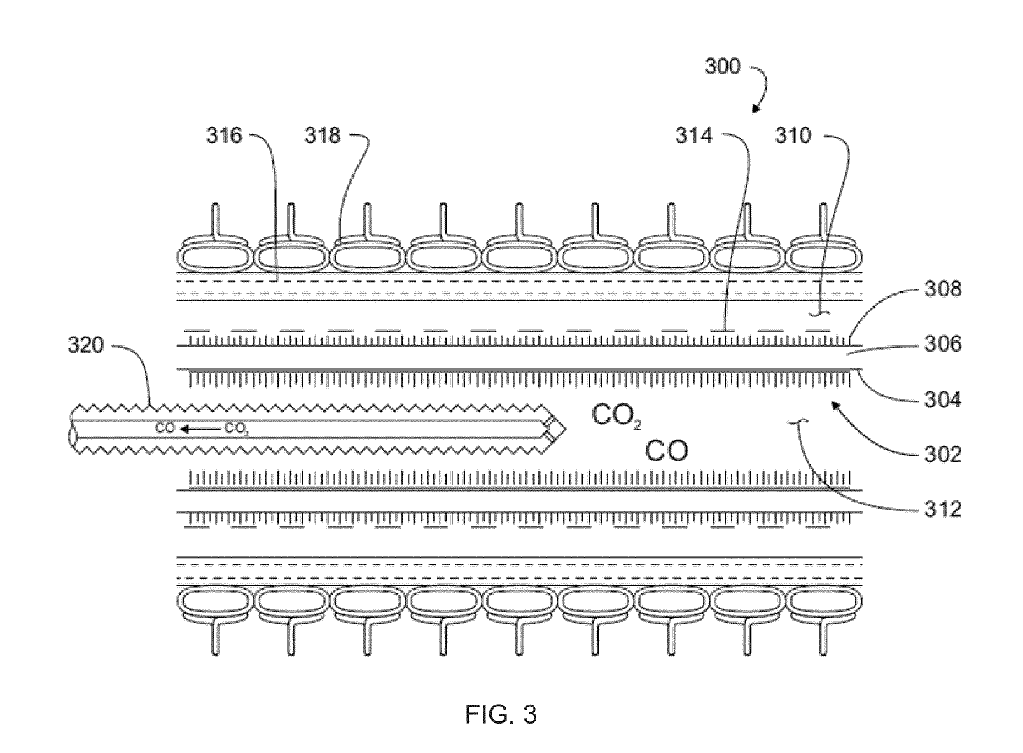

FIG. 3 shows a diagram of a system 300 that can be implemented for occasional and/or cyclic deposition or hot banking of one or more allotropes of carbon 302, e.g., such as graphene, tubes, or acicular crystalline or amorphous structures, along with production of pressurized or non-pressurized hydrogen that is delivered from near anode 304 (e.g., by reactions like that of Equations 1 or 2) to annular accumulator space 310 around cathode 308 following hydrogen ion passage through proton membrane 306. For example, the carbon allotropes that are particularly suitable for short-term banking include amorphous carbon that is produced by providing heat addition to a carbon donor substance such as methane provided in the central region of accumulator 312.

Alternatively, for example, heat addition through the anode 304 can produce crystalline structures depending upon influences such as epitaxial orientation and/or by seed materials, e.g., such as graphite, diamond, nickel, silicon, silica, germanium, iron, Fe₃C, cobalt, platinum, or various crystalline structures of the type of material chosen for selected portions of the anode 304. Heat addition by resistive and/or inductive input from elements 314 produces heat transfer through the cathode 308 to the proton transport membrane 306 to the anode 304. Accordingly endothermic heat is provided on or through growing crystals to precipitate amorphous or more organized forms of carbon. Depending upon the rate of heat addition, the gas within the accumulator 312 may receive sufficient heat transfer by conduction, convection, and/or radiation to produce amorphous and/or crystalline material with substantial defects and faults as desired for rapid deposition and gasification purposes and/or as fuel for a carbon fuel cell.

Upon introduction of steam for the endothermic process of Equation 3, the initial conversion is by contribution of carbon from amorphous portions or more highly defect characterized portions of the banked carbon. This allows separation and collection of high value nanotubes that can be collected by a suitable conveyer 320 within the accumulator 312 in a collection process of the disclosed methods.

In some implementations of the system 300, the system 300 can be implemented as a hot carbon fuel cell, as described later. In such implementations, for example, air (e.g., compressed air) can supply oxygen that is preheated in a helical heat exchanger tube 318 that reinforces a composite containment tube 316 by exhaust gases.

In some implementations of the disclosed technology, exemplary systems can be operated to provide production of electricity by one or more fuel cell processes in which some or all of the hot banked carbon is consumed to produce carbon monoxide and/or carbon dioxide by suitable reactions such as shown below (e.g., Equations 6A-6B for CO₂ production and Equations 6C-6D for CO operation and/or by reaction of carbon dioxide produced by a heat engine or carbon fuel cell with HBC to produce carbon monoxide). This combination allows the engine to be devoted to shaft power for applications such as propulsion without parasitic auxiliary drives for electricity generation, air conditioning compressors, fuel pumps, or hydraulic steering etc., and provide higher performance. Much greater electric power can be produced at far higher hydrogen, carbon and/or carbon monoxide fuel cell efficiencies (and thus avoid the engine-generator efficiency limitation) to more flexibly meet growing demands for electricity including reversible motors for hybridized propulsion and regenerative braking.

C+2O⁼→CO₂+4e⁻(Anode) Equation 6A

O₂+4e⁻→2O⁼(Cathode) Equation 6B

C+O⁼→CO+2e⁻(Anode) Equation 6C

O+2e⁻→O⁼⁻(Cathode) Equation 6D

C+2NaOH+O₂→Na₂CO₃+H₂O Equation 6E

Numerous anode, ion exchange medium, and cathode materials and operating arrangements may be selected including, for example, any of the following.

Example i) A fused tin anode on a solid oxide to maintain dissolved carbon concentrations and form tin oxide to react with carbon to release CO₂ or CO upon arrival of oxygen ions (O⁼) delivered from the cathode by the solid oxide membrane (e.g. zirconia). Solid oxide fuel cells tolerate sulfur and carbon monoxide at 800° C. (1480° F.) or higher temperature.

Example ii) A molten carbonate ion exchange electrolyte such as a fused carbonate salt solution suspended in a ceramic aluminum lithium oxide (AlLiO₂) at about 650° C. (1220° F.) to provide carbonate ion transport (CO⁼₃) in which feedstock of hot banked carbon is converted into ions at the cathode and enter into the exchange membrane as carbonate ions (CO⁼₃). Such carbonate ions are converted to CO₂ and/or CO at the anode as electrons are transported through the external circuit to the cathode. Hot molten carbonate fuel cells are not poisoned by carbon monoxide or carbon dioxide and allow operation in the Equations 6A-6B or 6C-6D modes. Cogeneration operations with a piston or turbine engine burning hydrogen can provide overall fuel efficiency of about 65 to 85%.

Example iii) A molten hydroxide NaOH or KOH—NaOH eutectic (e.g. about 46% KOH and 54% NaOH) providing ion exchange at 450 to 600° C. (840 to 1110° F.).

Example iv) A solid oxide system in which oxygen is ionized at the cathode and transported through a solid oxide such as zirconia to the anode where hot banked carbon is converted to carbon dioxide or carbon monoxide at a suitable temperature such as 800° C. (1480° F.) or higher temperature.

Various other fuel cell arrangements include mixed electrolytes such as hydroxide and/or carbonate electrolytes and/or nitrate electrolytes. Other variations include fluidized beds with pass through wire electrodes such as slurries of carbon with mixed alkali carbonates that operate up to about at 1000° C. (1830° F.).

In some implementations of the disclosed technology, exemplary systems can be operated to provide a molten caustic soda battery system that converts carbon to caustic soda as electricity is produced. In operation the molten electrolyte is converted to caustic carbonate as shown in Equation 6E. This exemplary system can utilize a sodium hydroxide, sodium-potassium eutectic or other mixture or caustic selection including calcium hydroxide and/or magnesium hydroxide or provide for mixed nitrates and hydroxides as the caustic. Such fuel cell or battery operations can be combined with a heat engine or another fuel cell to utilize waste heat and produce electricity along with solids that incorporate an oxide of carbon to produce valuable products, e.g., such as sodium, potassium, magnesium and/or calcium carbonate, to prevent emissions of carbon dioxide. An illustrative embodiment provides a molten electrolyte of KOH—NaOH into which CaO₂ is added at the rate that CaCO₃ is formed.

In some implementations of the disclosed technology, exemplary systems can utilize selected Perovskites (AB0₃) as proton and/or oxygen ion transport membranes in a reversible fuel cell application of the system. For example, a proton transport utilizes a gaseous hydrogen donor such as ammonia, hydrocarbon CₓH_{y} and/or steam heated by regenerative heat exchanges and provides for dissociation of the hydrogen donor such as steam on a hot assembly of electrode-A, proton membrane, electrode-B fuel cell that separates ionized hydrogen as it is selectively transported from electrode-A through the proton membrane for producing diatomic hydrogen upon receiving electrons from an external circuit to electrode-B. Such hot hydrogen can be cooled by counter-current heat exchange to heat the hydrogen donor compound. After being cooled by such useful regenerative heat transfer the hydrogen can be used to advantageously fuel an engine 132 or a fuel cell 190 of the system 130F of FIG. 1D. In instances that the hydrogen donor dissociation produces the hot banked carbon, another variety or region of Perovskite or zirconia membrane transports oxygen ions from electrode-D to such carbon at electrode-C to produce electricity and carbon dioxide as in Equation 6A. In some implementations, for example, CaO₂ can be added at the rate that CO₂ is produced to form CaCO₃.

Numerous advantages can be provided by direct conversion of the hot banked turbostatic or amorphous carbon chemical and thermal energy into electricity including the very low entropy change. Even at elevated temperature of 1000° C., the entropy change is 0.67 cal/K-mol for carbon oxidation to carbon dioxide.

The disclosed systems and methods can be implemented to allow interchangeable utilization of a large variety of fuels that contain carbon and hydrogen such as kerosene, diesel, jet fuels, gasoline, methane, propane etc., along with substances that may contain nitrogen, silicon, and sulfur such as ammonia, urea, landfill and/or sour gas. As shown in Table 1, considerable advantages can be achieved by utilizing as much low grade heat from engine coolant and higher grade exhaust sourced heat as possible along with enough higher grade regenerative energy to meet the endothermic energy requirements and rapidly produce the products shown to gain the greater chemical fuel potential energies corresponding to such endothermic energy additions. The hydrogen can be utilized by the exemplary system embodiments disclosed to provide superior stratified combustion results, for example, as compared to the feedstock hydrocarbons along with achievement of Tier 4 goals without requirements for exhaust recirculation or after treatment.

TABLE 1
Fuel Values of Dissociated Hydrocarbons CₙH₍₂ₙ₊₂₎ + HEAT → nC + (n + 1)H₂

| HxCy | HV of HxCy | Req. E | H2 HV | C HV | Prod. HV | |
|---|---|---|---|---|---|---|
| Formula | [kJ] | [kJ] | [kJ] | [kJ] | [kJ] | Increase % |
| Methane | −802.292 | 74.87 | −483.652 | −393.51 | −877.162 | 109.332 |
| Ethane | −1428.498 | 84 | −725.478 | −787.02 | −1512.498 | 105.8803 |
| Propane | −2043.134 | 104.7 | −967.304 | −1180.53 | −2147.834 | 105.1245 |
| Butane | −2657.57 | 125.6 | −1209.13 | −1574.04 | −2783.17 | 104.7261 |
| Pentane (L) | −3245.006 | 173.5 | −1450.956 | −1967.55 | −3418.506 | 105.3467 |
| Hexane (L) | −3855.142 | 198.7 | −1692.782 | −2361.06 | −4053.842 | 105.1542 |
| Heptane (L) | −4464.778 | 224.4 | −1934.608 | −2754.57 | −4689.178 | 105.026 |
| Octane (L) | −5074.214 | 250.3 | −2176.434 | −3148.08 | −5324.514 | 104.9328 |
| Nonane (L) | −5685.15 | 274.7 | −2418.26 | −3541.59 | −5959.85 | 104.8319 |
| Decane (L) | −6294.186 | 301 | −2660.086 | −3935.1 | −6595.186 | 104.7822 |
| Undecane (L) | −6903.322 | 327.2 | −2901.912 | −4328.61 | −7230.522 | 104.7397 |
| Dodecane (L) | −7513.758 | 352.1 | −3143.738 | −4722.12 | −7865.858 | 104.6861 |

Table 2 shows that substantially greater chemical potential energy benefits can be provided by endothermic reformation or respeciation of such hydrocarbons and an oxygen donor, e.g., such as an alcohol and/or water. This greater gain in chemical fuel potential energy is accompanied by present embodiments to provide advantageous utilization of gaseous carbon monoxide as a J-T expansive coolant that can subsequently be rapidly utilized as a fuel value by hydrogen characterized accelerated combustion after TDC in virtually any overall air-fuel ratio produced by throttled or unthrottled engine operation including exceptionally lean operation.

TABLE 2
Steam Reformed Hydrocarbons ₙH₍₂ₙ₊₂₎ + nH₂O + HEAT → nCO + (2n + 1)H₂

| | HV of HC | Req. E | H2 HV | CO HV | Prod. HV | |
|---|---|---|---|---|---|---|
| HxCy | [kJ] | [kJ] | [kJ] | [kJ] | [kJ] | Increase % |
| Methane | −802.292 | 206.166 | −725.478 | −282.98 | −1008.458 | 125.6971 |
| Ethane | −1428.498 | 346.592 | −1209.13 | −565.96 | −1775.09 | 124.2627 |
| Propane | −2043.134 | 498.588 | −1692.782 | −848.94 | −2541.722 | 124.4031 |
| Butane | −2657.57 | 650.784 | −2176.434 | −1131.92 | −3308.354 | 124.4879 |
| Pentane (L) | −3245.006 | 829.98 | −2660.086 | −1414.9 | −4074.986 | 125.5771 |
| Hexane (L) | −3855.142 | 986.476 | −3143.738 | −1697.88 | −4841.618 | 125.5886 |
| Heptane (L) | −4464.778 | 1143.472 | −3627.39 | −1980.86 | −5608.25 | 125.6109 |
| Octane (L) | −5074.214 | 1300.668 | −4111.042 | −2263.84 | −6374.882 | 125.6329 |
| Nonane (L) | −5685.15 | 1456.364 | −4594.694 | −2546.82 | −7141.514 | 125.617 |
| Decane (L) | −6294.186 | 1613.96 | −5078.346 | −2829.8 | −7908.146 | 125.6421 |
| Undecane (L) | −6903.322 | 1771.456 | −5561.998 | −3112.78 | −8674.778 | 125.6609 |
| Dodecane (L) | −7513.758 | 1927.652 | −6045.65 | −3395.76 | −9441.41 | 125.655 |

In some implementations, for example, it can be advantageous to use a portion of the carbon for production of durable goods and/or direct production of electricity. As shown in Tables 3 and 4 the theoretical limit for a carbon fuel cell efficiency for minimal entropy changes is about 100% for operating temperatures up to about 1000° C. (1273° K or 1830° F.). For example, this compares to a hydrogen fuel cell with a theoretical limit of about 82% at far lower temperatures such as R.T. Further utilization of hydrogen and/or carbon monoxide in fuel cell operations at elevated temperatures can incur reduced voltage compared to ambient temperature processes.

TABLE 3
Gibbs Free Energy, Enthalpy and Fuel Cell Efficiency (Eff = ΔG/ΔH)

| | | | |
|---|---|---|---|
| H₂ + .5O₂ → H₂O | ΔG_{298.° K} = −237.14 kJ/mol | ΔH_{298.° K} = −285.83 kJ/mol | Max Eff. = 82.9% |
| | ΔG_{1273° K} = −177.3 kJ/mol | ΔH_{1273.° K} = −249.4 kJ/mol | Max Eff. = 71.1.2% |
| CO + .5O₂ → CO₂ | ΔG_{298° K} = −257.2 kJ/mol | ΔH_{298.° K} = −283 kJ/mol | Max Eff. = 90.8% |
| | ΔG_{1273° K} = −172.0 kJ/mol | ΔH_{1273.° K} = −281.5 kJ/mol | Max Eff. = 61.1.2% |
| C + O₂ → CO₂ | ΔG_{298.15° K} = −394.4 kJ/mol | ΔH_{298.° K} = −393.5 kJ/mol | Max Eff. =>100% |
| | ΔG_{1273° K} = −396.3 kJ/mol | ΔH_{1273° K} = −395.2 kJ/mol | Max Eff. =>100% |

TABLE 4
Gibbs Free Energy for Hydrocarbon Dissociation Product Oxidations

| | 25° C. (298.15° K) | | | 1000° C. (1273.15° K) | | |
|---|---|---|---|---|---|---|
| | H2 ΔG | C(s) ΔG | Total ΔG | H2 ΔG | C(s) ΔG | Total ΔG |
| HxCy | [kJ] | [kJ] | [kJ] | [kJ] | [kJ] | [kJ] |
| Methane | −457.164 | −394.432 | −851.596 | −354.592 | −396.313 | −750.905 |
| Ethane | −685.746 | −788.864 | −1474.61 | −531.888 | −792.626 | −1324.51 |
| Propane | −914.328 | −1183.3 | −2097.62 | −709.184 | −1188.94 | −1898.12 |
| Butane | −1142.91 | −1577.73 | −2720.64 | −886.48 | −1585.25 | −2471.73 |
| Pentane (L) | −1371.49 | −1972.16 | −3343.65 | −1063.78 | −1981.57 | −3045.34 |
| hexane (L) | −1600.07 | −2366.59 | −3966.67 | −1241.07 | −2377.88 | −3618.95 |
| heptane (L) | −1828.66 | −2761.02 | −4589.68 | −1418.37 | −2774.19 | −4192.56 |
| Octane (L) | −2057.24 | −3155.46 | −5212.69 | −1595.66 | −3170.5 | −4766.17 |
| Nonane (L) | −2285.82 | −3549.89 | −5835.71 | −1772.96 | −3566.82 | −5339.78 |
| Decane (L) | −2514.4 | −3944.32 | −6458.72 | −1950.26 | −3963.13 | −5913.39 |
| Undecane(L) | −2742.98 | −4338.75 | −7081.74 | −2127.55 | −4359.44 | −6487 |
| Dodecane(L) | −2971.57 | −4733.18 | −7704.75 | −2304.85 | −4755.76 | −7060.6 |

Therefore, the exemplary systems that provide conversion of hot carbon in fuel cell operations at elevated temperatures efficiently produce electricity and allow utilization of hot carbon dioxide exhaust in regenerative heat exchanges to beneficially heat the hydrogen donor substance and/or to react with hydrogen to produce net-hydrogen liquid fuels, e.g., such as formic acid, fuel alcohols, DME or DEE. Also, for example, it can be advantageous to operate the hydrogen and/or carbon monoxide fuel cell at much lower temperature after beneficial regenerative heat exchange to heat the hydrogen donor substance.

Synergistic energy utilization benefits are also provided by injection of pressurized hot hydrogen at or after TDC in a host internal combustion engine to achieve expansive J-T heating and/or high efficiency Lorentz and/or corona ignition and/or accelerated initiation and completion of combustion for improved BMEP, performance and fuel efficiency along with readily achieving Tier 4 emissions limitations.

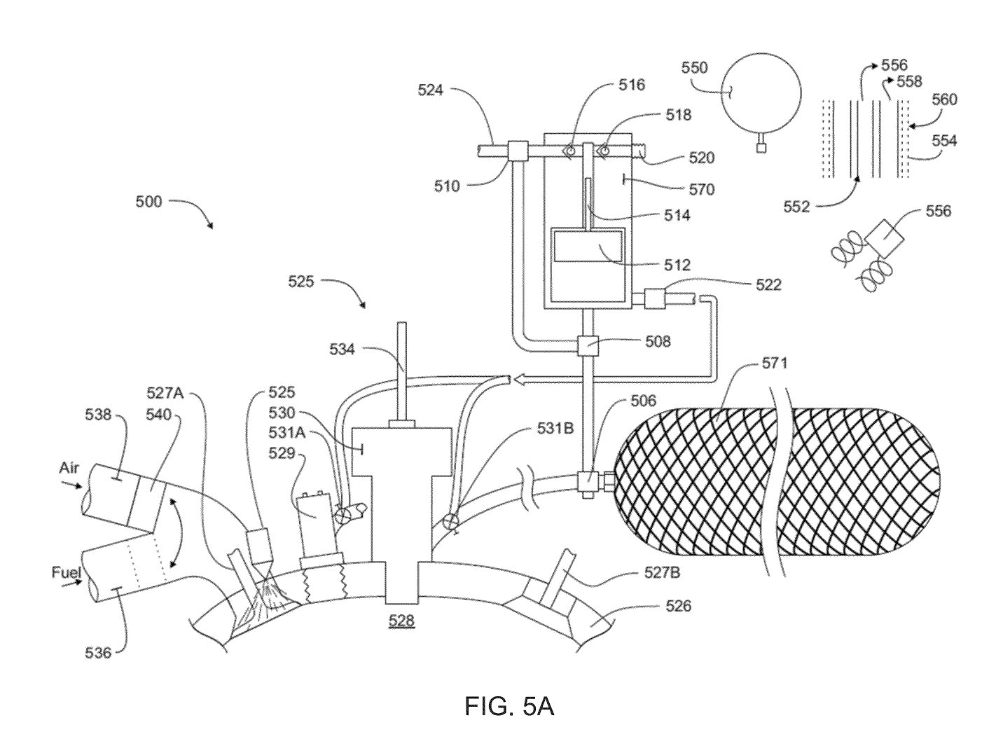

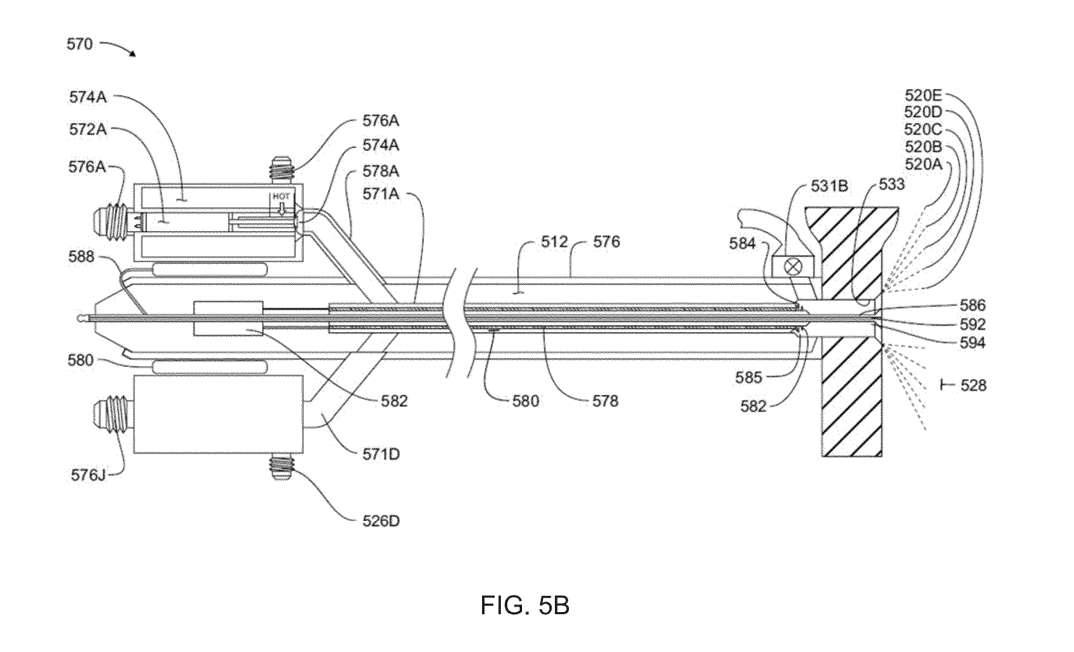

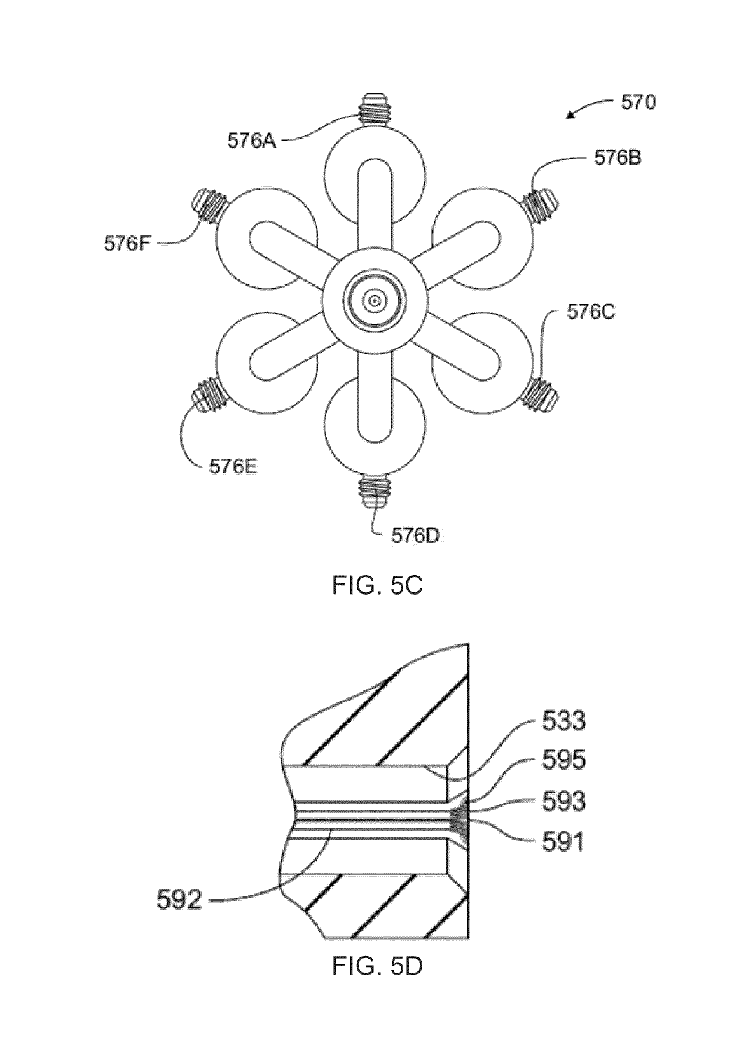

FIG. 1D shows a schematic diagram of another exemplary embodiment of a system of the disclosed technology for energy conversion and storage in an engine. As shown in FIG. 1D, a system 130F is configured to adaptively utilize a combination of fuel cells to optimize direct production of electricity from carbon, hydrogen, and carbon monoxide, e.g., such as may be produced by reactions typical to those listed in Tables 1 and 2. For example, a hot carbon-fueled fuel cell can be included in the system 130F, e.g., in the manifold assembly zone 100 and/or the zone 180, as shown in FIG. 1D. In some implementations, for example, the hot carbon-fueled fuel cell can be operated with oxygen from the air and/or from oxygen separation, exemplified by a system 500 shown later in FIG. 5A, in which the hot carbon fuel is oxidized to carbon monoxide or carbon dioxide by a fused or solid oxide membrane fuel cell operated at elevated temperature such as 500 to 1500° C. In some implementations, for example, the hot carbon-fueled fuel cell can be operated using heat exchanges from hot hydrogen and/or carbon monoxide to preheat carbon donor substances such as CxHy. In some implementations, for example, operation can occur at the same or lower temperature of a solid oxide fuel cell, e.g., such as in the zone 180 or the zone 400Z of the system 130F, that oxidizes carbon monoxide and/or hydrogen to carbon dioxide and/or H₂O. In some implementations, for example, operation can occur at lower temperature of a proton exchange membrane (PEM) fuel cell that oxidizes hydrogen to H₂O, e.g., such as operation in the zone 190 of the system 130F, which allows rapid high-efficiency startup operations to produce electricity from cool hydrogen as shown.

As noted in Table 3, the high Gibbs free energy available for direct production of electricity by the high temperature carbon fuel cell embodiment allows greatly improved rate (or current) while retaining full voltage production efficiency at 1,000° C. (1273.15° K), e.g., as compared to ambient temperature operation. In addition to improved efficiency the high temperature carbon-fueled fuel cell is readily reversible to provide occasional hot carbon energy storage including optimization of off-peak and regenerative energy.

Illustratively, for example, a large inertia load (e.g., such as a descending rail train) can produce energy that is rapidly and densely stored as compact carbon that can be utilized subsequently to produce energy and/or feedstock for durable goods production by on or off-board manufacturing procedures.

In addition to large inertia applications such as rail trains, for example, smaller vehicles can utilize hot banked carbon to improve overall fuel economy and participate in energy production and distribution. Illustratively, a hot banked carbon fuel cell can overcome the large environmental impact of inefficient fossil fuel use and lead-acid batteries. Typical electricity production by an internal combustion engine powered alternator and lead-acid battery is 15% or less (0.35 ICE) (0.65 Alternator) (0.65 Battery)=15% or less. Cooled carbon monoxide (e.g., 90% theoretical cool fuel cell efficiency or somewhat lower efficiencies at moderate temperatures) and/or hot carbon-fueled fuel cells with 100% theoretical efficiency at 1000° C. can produce electricity at 60 to 85% operating efficiency and can continue to do independently or so long before, during, or after the host engine is shut down.

In some implementations, this can be facilitated by utilization of engine waste heat for a substantial portion of the endothermic heat and/or suitable application of electric energy required to dissociate and separate typical hydrocarbon feedstocks into hot hydrogen and carbon. The hot carbon fuel is co-produced with reverse fuel cell pressurization of hydrogen by endothermic dissociation of (CₓH_{y}) using H1 (heat from engine coolant), H2 (heat from exhaust gases), and H3 (combustion heat and/or electricity such as from regenerative brakes and shock absorbers).

FIGS. 2A, 2D, 3 and 4 show exemplary embodiments of systems that can facilitate carbon fuel cell reactions that follow hot carbon precipitation or deposition as hot hydrogen is separated and injected in an engine, e.g., such as engine 132 of FIG. 1C or 1D, or stored in an accumulator, e.g., such as accumulator 272 of FIG. 1C or 1D, or utilized as a heat source for heating hydrogen donor feedstock and then utilized in a fuel cell such as a low temperature fuel cell 190 of the system 130F, shown in FIG. 1D. In such instances, for example, hot carbon produced in the manifold assembly zone 100 can be transferred by a conveyer 320 (of the system 300 shown in FIG. 3) to the fuel cell in the zone 180 for production of electricity and carbon dioxide and/or carbon monoxide. Hydrogen can be utilized as a hot pressurized fuel for injection in an engine, e.g., such as the engine 132, at or after TDC to produce J-T expansive heating, serve as a pattern former for efficient Lorentz and/or corona ignition, and/or occasionally as a fuel in cooler fuel cell operations such as provided by the fuel cell 190.

FIG. 2C shows a diagram of another exemplary system of the disclosed technology for production of hot carbon and hydrogen and implementations in fuel cell applications. FIG. 2C shows a system 200H that can provide pressurization of hydrogen and/or carbon monoxide and/or carbon dioxide and/or nitrogen by endothermic phase changes and/or reactions in one or more canisters, e.g., shown in FIGS. 2C and 2D as canisters 222B, 222C, 222D, 222E, 222F, 222G. The phase changes and/or reactions operated in the system 200H can be operated similarly to that of the system 200 along with storage of hot, pressurized hydrogen in a heat banking accumulator 272H of the system 200H. In implementations, for example, hot, pressurized hydrogen may be delivered for direct fuel injection at or after TDC by injectors 166. Pressurization operations in the canisters 222B-222G may be intermittent to provide cyclic relative low pressure charging of accumulators, e.g., such as the accumulators 256 of the system 200 or 256H of the system 200H, with fuels (e.g., CxHy, NH₃, CH₄N₂O, etc.), and heating by hot banked carbon to produce higher pressure and/or further galvanic pressurization as separated hydrogen is delivered to accumulator zones, e.g., such as the accumulators zone 260 of the system 200 or 260H of the system 200H, and the accumulator 272H of the system 200H.

Referring back to FIG. 3, the system 300 can be operated as a hot carbon fuel cell for transporting oxygen ions to react with hot carbon to produce electricity. In the exemplary hot carbon fuel cell, oxygen ions, e.g., from oxygen or air, are transported in accumulator annulus 310 through oxygen ion membrane 306 to react with carbon and produce electricity that is delivered to and from external circuits by conductive electrodes 308 and 304. Hot carbon dioxide produced and accumulated in the accumulator 312 can in part be shifted to carbon monoxide on various occasions and for various purposes including operation of a carbon monoxide and/or hydrogen fuel cell and/or for supplementing the supply of expansive cooling fuel for injection before TDC in the combustion chambers of the host engine to improve BMEP and/or to produce liquid fuels such as methanol, ammonia or urea as shown by Equations 7A-7F. Air compressed by a suitable subsystem such as embodiment 500 can supply oxygen that is preheated in helical heat exchanger tube 318 to reinforce composite containment tube 316 by exhaust gases to further improve the hot carbon fuel cell capacity and efficiency.

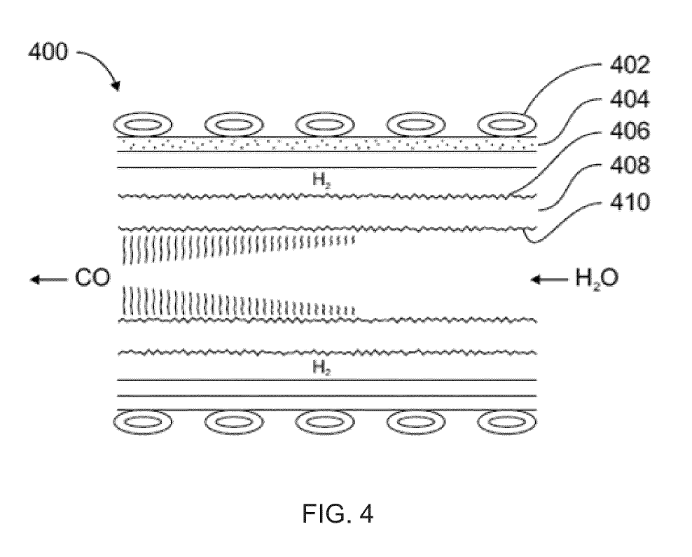

Certain applications of the disclosed technology can provide controllable production of hydrogen from the hot carbon by reaction with steam. FIG. 4 shows a diagram depicting an implementation of production of hydrogen from the hot carbon by reaction with steam in a system 400. In some implementations, the system 400 may be separated or positioned proximate to the system 300 for utilization of hot carbon delivered by the conveyer 320. The system 400 includes a tubular heat exchanger 402 that can be utilized to receive heat from exhaust gases to preheat the steam that is introduced to react with the hot banked carbon. The system 400 includes a reinforced composite containment tube 404 that provides an annular passageway for hot hydrogen that can be pressurized by application of a voltage gradient across proton exchange tube 408 of the system 400 between electrode 406 and 410 of the system 400. For example, such hot high pressure hydrogen can be utilized to produce fuels, e.g., as shown later in Equations 7A-7F, and may also be utilized as a J-T expansion heating fuel for injection at or after TDC to improve BMEP and engine efficiency.

FIG. 5A shows a schematic diagram of an engine employing an exemplary system of the disclosed technology for energy conversion and production of specialized fuels. Air can be compressed by the system 500 of FIG. 5A including operation to provide further pressurization by an intensifier unit 570 of the system 500. The intensifier unit 570 can include a piston assembly 512-514 and controlled valves or check valves 516-518 for delivery of the pressurized air through conduit 520 to an accumulator 550 of the system 500 for separation into oxygen rich and nitrogen rich portions by a separator system that is placed in line between the outlet conduit 520 and the accumulator 550, or after the accumulator 550. Illustratively, a representative portion of a suitable separator system is shown as assembly 560 including reinforced composite outer tube 554, annular passage 558 between outer tube 554 and inner tube filter 552 to deliver nitrogen rich compressed gas from annular passageway 558 and oxygen rich gas from passageway 556. In a regenerative deceleration mode according to operation by controller 556, the host engine receives throttled or unthrottled air through intake valve 527A and produces compressed air during the compression stroke an adaptive portion of which is conveyed through valve 531A of a device 529 that may replace a glow plug, and/or valve 531B of an injector 530 to deliver compressed air into tank 561.

In some implementations, for example, regenerative engine deceleration capacity is increased by maximizing the volumetric efficiency including allowing unthrottled air to pass through the valve 540 from passageway 538 and enter the combustion chamber 528 through valve 527A during intake. Also, for example, in subsequent similarly equipped combustion chambers, unthrottled air enters the combustion chamber and may be supplemented with additional air that is added through the valves 531A and/or 531B from the tank 571 (or, e.g., the accumulator 550) or similar storage vessels to increase the work of compression and deceleration of the host engine as additional compressed air is stored in vessels, e.g., such as the tank 571 or the accumulator 550. Such regenerative deceleration and production of high pressure oxygen is highly beneficial for combustion of fuel such as CH₄, H₂, NH₃ etc., to provide supplemental heat and/or to increase the temperature of reactions such as shown in Equations 1 or 2, or Equations 6F or 6G (shown below), or for efficient operation of the exemplary hot banked carbon fuel cells, such as those that can be located in the manifold zones 100 and/or 180 in FIG. 1D, and/or one or more hydrogen fuel cells, e.g., such as the exemplary fuel cell assembly 190 that various system embodiments of the disclosed technology can utilize.

In some exemplary embodiments of the system 500 of FIG. 5A, another manifold with conduits similar to 536 538, and valve 540 is provided for delivering compressed gas received through exhaust valve 527A at times that the piston moves upward toward TDC and/or after TDC to deliver compressed gas to a valve 506 for distribution to a valve 508 and/or the tank 561 or 571. Operation of valve 527B at such times may be provided by a suitable method such as an air or hydraulic cylinder, solenoid or amplified piezoelectric actuator or by a direct or indirect acting cam lobe through a hydraulic lifter, rocker arm or pushrod.

In some applications, for example, such regenerative deceleration of the host engine and thus a vehicle, elevator, or conveyer system etc., is provided by compression of a fuel, e.g., such as methane or hydrogen, by admission through the passageway 536, the valve 540, and intake valve 527A for delivery to one or more suitable fuel storage tanks 561 similar to 571, as previously described for production of compressed air. In some instances such compressed fuel or compressed air powers the intensifier unit 570 to produce much higher pressure fuel selections such as disclosed herein, e.g., including NH₃, CO, CH₄ and/or H₂ or another fluid including suitable pressures for direct injection at high pressure in converted turbocharged diesel engines at or after TDC.

The system of FIG. 5A can provide pressurization of gaseous and liquid fuel selections and/or allows air separation into pressurized oxygen and nitrogen rich streams along with thermal pressurization by some exemplary systems of the disclosed technology, e.g., such as the system 200H shown in FIGS. 2C and 2D. In operation, for example, fuel and/or reactants (e.g., such as water, oxygen or nitrogen) are cyclically charged into the accumulator space 256H within the anode 257H of the system 200H to utilize banked carbon and/or to produce hydrogen by reactions noted previously including Equations 1, 2, 6A, 6B, 6C, 6D, 6E and or by conversion of banked carbon as noted below by Equations 6F and 6G.

2C+2H₂O+O₂→2CO₂+2H₂ Equation 6F

3C+H₂O+O₂→3CO+H₂ Equation 6G

As an example of cyclic pressurization operation by the system 130 of FIG. 1C or the system 130F of FIG. 1D, and the system 200H of FIGS. 2C and 2D, the pump 140 of the systems 130 or 130F can be configured as a mechanical pump, e.g., such as a positive displacement or impeller type and/or a thermal pressurization system in which multiple cells cyclically receive liquid that is converted into pressurized vapor that is delivered through the valve 144 to the circuits shown. In one mode of operation, such pressurized fluid fuel is preheated in a countercurrent circuit of heat exchange assemblies 174, 146, and/or 134 and enters into accumulator chambers 256H of the system 200H to produce hot banked carbon and hydrogen that is transported to the accumulator 260H and thus to hot storage in 272H. Chambers 256H of the system 200H are cyclically further pressurized by proportioned charges of steam and/or oxygen that have been heated by heat exchangers 134 and/or by further heat additions from sources such as renewable and/or regenerative energy. This allows cyclic pressurizations of hot accumulator 272H of J-T expansive heating substances (e.g., hot hydrogen) and/or cyclic pressurization of cool storage in the accumulator 274 of J-T expansive cooling substances (e.g., carbon monoxide, nitrogen and/or carbon dioxide).

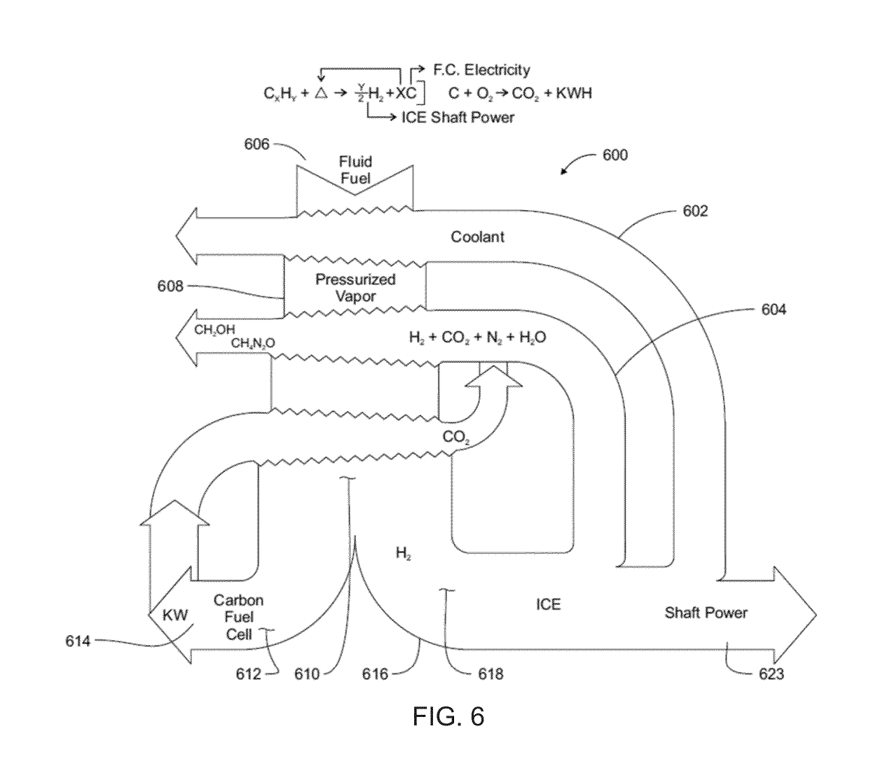

FIG. 6 shows a diagram depicting fuel conditioning events 600 of an exemplary system of the present technology that utilizes heat sources, e.g., such as engine coolant 602 and/or exhaust gases 604, to convert various gases, mixed-phase fluids, or liquid fuel selections 606 (e.g., CₓH_{y}) into vapor 608 by heat addition to cause such phase change and/or thermal pressurization. The pressurized fuel vapor 608 is then dissociated into separated carbon 612 and hydrogen 616 by further heat addition from engine exhaust gases and/or other regenerative heat sources.

In exemplary implementations, the separated hydrogen can be produced by endothermic reaction on the anode 257 and delivered through the proton exchange membrane 258 to the cathode 216 to be further pressurized by application of an applied voltage between the anode 257 and the cathode 216. Thus separated hot hydrogen can be further pressurized in a process 618 shown in FIG. 6 by galvanic impetus (e.g., applied voltage such as from regenerative sources) for purposes of increasing the BMEP and thermal efficiency of an internal combustion engine by direct injection, J-T expansion heating, and accelerated combustion after TDC as a stratified charge to maximize air utilization efficiency for improved performance and production of shaft power 623. Also, in exemplary implementations, the separated hot carbon can be utilized in a high temperature fuel cell, e.g., such as the fuel cell system 300, to efficiently produce electricity and carbon dioxide in a process 614 shown in FIG. 6. Exemplary hot carbon dioxide can be utilized to transfer heat to the dissociation process 610 and/or to be mixed with hot exhaust gases from an engine (e.g., such as the engine 132 of the systems 130 and/or 130F) to accelerate the vaporization and dissociation processes. In certain exemplary embodiments, such carbon dioxide can be separately delivered and subsequently reacted with hydrogen to produce liquid fuels, e.g., as summarized by the Equations 7A-7F.

The carbon and oxygen reactants along with the product such as carbon monoxide or carbon dioxide can effectively be considered as pure substances in separate phases thus the chemical potentials are constant and independent of the extent of fuel conversion. This allows all of the carbon that enters the circuit to be converted in a single step. Fuel cell electrode polarization is minimal for atomically disordered hot banked carbon such as provided by embodiments that provide rapid deposition of carbon. Particularly effective production of hot banked amorphous carbon is achieved by separation of hydrogen as it is produced by a proton membrane and/or by application of voltage to accelerate hydrogen ion production and transport from the anode to the cathode.

Such rapidly deposited disordered carbon and commensurately high rates of hydrogen production can facilitate hot hydrogen injection after TDC to maximize J-T expansive heating, accelerated combustion, and higher engine efficiency. For example, the fuel efficiency of piston engines with such improvements can be 50% or higher. By overcoming the heat engine limitation of first converting fuel potential energy to mechanical work that is applied to an alternator, for example, the efficiency of electricity production is more than doubled. Utilizing more efficient electric drives, e.g., instead of engine-mechanical-hydraulic systems, can further increase overall efficiency.

Various combined regenerative thermochemical processes, fuel cells, and/or heat engines options can include the following examples. For example, regenerative thermochemical processes, fuel cells, and heat engines options of some exemplary combinations can include (1) production of net hydrogen liquid fuel carriers (HFCs) from hydrogen, nitrogen, carbon monoxide or carbon dioxide including carbon donor fuels; (2) thermal separation of hydrogen, carbon, and/or carbon monoxide from compounds containing carbon and hydrogen and/or nitrogen and hydrogen; (3) direct injection of hot J-T expansion heated hydrogen after TDC to increase combustion engine BMEP, performance, and fuel efficiency; (4) hot carbon and/or carbon monoxide fuel cell production of electricity to overcome efficiency limitations and power requirements of engine-generator electricity production; and/or (5) utilization of heat rejected by engine coolant and/or exhaust gases and/or by fuel cells to preheat and thermochemically convert HCFs to carbon and/or carbon monoxide and/or hydrogen for fuel cell operations and hydrogen and/or carbon monoxide for heat engine operation.

Illustratively, the high temperature carbon fuel cell can be complemented by a hot, warm, or lower temperature hydrogen fuel cell, e.g., such as the exemplary fuel cell assembly 190, that provides quicker start-up and/or occasional operation without any carbon dioxide emissions. One or more low temperature hydrogen fuel cells can utilize proton exchange membranes such as sulfonated tetrafluoroethylene copolymerized with fluropolymer (e.g., Nafion) and operate near the ambient temperature. Higher temperature fuel cells, e.g., such as the exemplary fuel cell system 400, can utilize molten hydroxide, solid oxide or composited carbon based proton exchange membranes.

In some applications, for example, two or more types of fuel cells can be utilized to further increase the operational flexibility, efficiency, and range of vehicles. Other advantages include production of condensable potable water and the option of quiet running in electric only mode with or without emissions of oxides of carbon. Quiet running embodiments can be utilized by stationary or mobile systems, e.g., such as at night, to prevent neighborhood disturbances by delivery vehicles or more general traffic noise or in other sensitive areas or occasions.

Carbon fuel cells operating at high temperatures facilitate the operational embodiment of producing carbon monoxide as an exhaust and developing a higher open cell voltage. For example, such carbon monoxide can be utilized to produce polymers, chemicals or as fuel in the host engine. Other embodiments provide the option of shifting to reduced operating voltage but produce two-times greater current as carbon dioxide is produced. In some instances, for example, the production of carbon monoxide along with electrical energy is combined including application of such carbon monoxide in processes that synthesize polymers, chemicals or liquid fuels such as alcohols, ethers etc., e.g., such as illustratively depicted by Equation 7A. In other embodiments, for example, such carbon monoxide is reacted with steam to produce hydrogen and carbon dioxide.

Such hydrogen can be used in the host engine and/or to fuel a hydrogen fuel cell and/or to provide hydrogen for processes, e.g., such as illustrated by Equation 7A-7C. For example, in some implementations, another complementary embodiment can produce carbon monoxide after carbon dioxide has been produced by the fuel cell process in accordance with the reverse Boudouard reaction, e.g., in which carbon or HBC reacts with carbon dioxide emitted by the fuel cell at temperatures above about 650° C. (1200° F.) to provide carbon monoxide in an energy conserving or regenerative step.

These operational embodiments can allow environmental betterment and provide much greater return on substantial investments in UPS engine-generators, e.g., which have previously been limited to emergency operation due to unacceptable emissions from conventional operation on hydrocarbons, e.g., such as natural gas, propane, gasoline, jet or diesel fuels. Conversion and operation of such engines by the methods and systems of the present technology allow such engines to meet emission restriction requirements with improved thermal efficiency and to utilize much less expensive fuel selections along with extended engine life.

In some implementations, the disclosed methods and systems can provide for partial oxidation of selected carbon allotropes by an oxygen donor such as oxygen from water electrolysis or from the air (according to SuperPower Operations or as may be provided on-board a vehicle by membrane and/or PSA separation). In one exemplary mode, such oxygen is cyclically used to produce CO and remove deposited carbon from the anode catalyst. Such CO generation can favorably boost pressure in the accumulator, e.g., such as the accumulator 256 of the system 200, by converting solid carbon to increase the gas inventory (2C+O₂→2CO) and the product may be cooled by heat exchange to the feedstock methane and stored in another accumulator, e.g., such as the accumulator 274, similar to the accumulator 272 of the system 200, for supporting various uses of carbon monoxide including reaction with hydrogen for production of polymers or liquid fuels, e.g., such as methanol (as shown in Equations 7A-7F), and/or for injection before TDC to perform beneficial expansive cooling to increase net BMEP.

CO+2H₂→CH₃OH Equation 7A

CO₂+3H₂→CH₃OH+H₂O Equation 7B

CO+2H₂+C→CH₃OH+C Equation 7C

CO₂+3H₂+C→CH₃OH+H₂O+C Equation 7D

N₂+3H₂→2NH₃ Equation 7E

CO+N₂+H₂→CH₄N₂O Equation 7F

For example, the hydrogen carrier fuel (HCF) produced by reactions such as Equation 7A and/or 7B can also serve as a carbon carrier fuel (CCF) as shown in Equations 7C and 7D for colloidal or soluble forms of carbon including agricultural, municipal and industrial waste substances. Carbon dioxide and/or carbon monoxide for such purposes can be extracted from the carbon fuel cell and/or engine exhaust in instances that it is presented. In operation, for example, such hydrogen and carbon carrier fuels can be thermochemically processed into numerous outcome permutations including separation of carbon for fuel cell production of electricity, hydrogen for fuel cell production of electricity, carbon monoxide for expansive J-T cooling and reduction of the work of compression in an internal combustion engine and hydrogen for expansive heating and combustion to increase the BMEP and fuel efficiency of a combustion engine operation.

FIG. 5B shows a schematic diagram of an exemplary embodiment of the intensifier unit 570 that allows direct injections of J-T expansive cooling substances and subsequent direct injections of J-T expansive heating substances along with separation of compressed gas from combustion chamber 528. Elevated temperature J-T expansion heating fluid such as hot hydrogen can be supplied through selected fittings 576A-576F, shown in a cross-sectional view in FIG. 5C, for insulated flow through control valves 575A-575F, to conduit 578A, the conduit within 578, control valve 584 for injection through the port into combustion chamber 528 as spray patterns 520A-520E.

Ionization of a controllable portion of the hydrogen injected can be produced by adaptive application of an ionizing voltage potential through conductor 586 from electrode points 585. If such voltage potential is maintained for a sufficient period of time an ion current is produced between one or more electrode points 585 and 533, which is accelerated toward the combustion chamber by the Lorentz thrust developed on such current. A rapidly increased ion population can be produced along with commensurately increased Lorentz thrust by continued application of a voltage across the gap between electrode zones 584 and 533.

Examples of techniques to produce Lorentz thrust are described in U.S. patent application Ser. No. 13/844,240 entitled “FUEL INJECTION SYSTEMS WITH ENHANCED THRUST”, and in U.S. patent application Ser. No. 14/273,482 entitled “SYSTEMS, METHODS, AND DEVICES WITH ENHANCED LORENTZ THRUST”, both of which are incorporated by reference in their entirety as part of the disclosure of this patent document.

Such Lorentz thrust can accelerate the ion currents and the hydrogen flow produced by pressure drop past valve 584 to produce one or more bursts of hydrogen into combustion chamber 528. FIG. 5D shows an enlarged view an end of the intensifier unit 570 including a sensor and/or actuator assembly. In this example, the intensifier unit 570 includes fiber optics 593 in filament bundle 592, conductive E-field filaments 591, and electromagnetic lens circuits 595 of this exemplary embodiment of the unit 570. The shape of such injections of hydrogen molecules and ions can be varied from a large included angle at full power to a much smaller included angle at idle as control functions including the fuel pressure drop and/or ion current, and/or by electromagnetic (EM) adjustment and/or electric (E) field strength by permanent or electromagnetic lens 533 or 595 or field adjustment by conductive filaments 591 within fiber optic bundle 592.

Cool hydrogen and other fluids such as J-T expansion cooling substances can be delivered through the fittings 576A-576F for controlled selection by operation of the valves 572A-572F for deliveries through the conduits 578A-578F to the valve 584 and injection into combustion chamber 528 as provided by valve operator 581. Such cool fluids can be injected or subjected to ionization and/or production of Lorentz current thrusting as disclosed regarding injection of hot hydrogen.

In certain embodiments, for example, the unit 570 includes a controller 580 that receives data through fiber optic and instrumentation filament bundle 588 to provide the following examples.

(1) For example, control of an inertial two component armature or piezoelectric valve operator such as 572 and/or 581 including varying the applied voltage to compensate for thermal expansion of assembled components and to provide fuel flow control in response to fiber optic sensor instrumentation 593 and/or crank-acceleration detection by a sensor such as a Hall effect or optical encoder and/or piston velocity and position detection by fiber optic filaments within filament bundle 592/593.

(2) For example, fuel pattern control starting with valves 574A-574F that can be multiply opened inward or outward to deliver fluid for injection control by piezoelectric operator 581 to allow fuel injection into combustion chamber 528. Injected substance ionization and/or Lorentz thrusting can be controlled by radial ionization edges or tips 582 or 585 for initiating ion and/or very small currents between electrodes 582 or 585 and 533. In Lorentz thrust embodiments such small currents suddenly reduce the resistance in the gap between electrode tips 582 or 585 and 533. Application of continued higher or lower voltage quickly causes production of large momentary currents such as may be provided by inductors and/or capacitors 597 within case 596 that experience Lorentz thrust forces to accelerate and launch the currents of ions along with swept fuel into combustion chamber 528.

(3) For example, after departure of such ions and swept fuel from the electrode gap between 585 and/or 582 and 533 nanosecond applications of high voltage to electrode 586 efficiently produce corona ignition in the desired-form patterns 520A-520E of fuel and ions that have been accelerated and launched into the compressed air in combustion chamber 528.

(4) For example, the included angle of the launched ions and swept fuel particles can be altered by embodiments that provide the electrode flow pathways such as splines including various straight and/or helical swirls in electrode 533 and/or 586, electro- or permanent magnet lens 595 within electrode 594, by laser or diode emitted UV patterns from one or more fiber optic filaments 593 in bundle 592 and/or by the polarity of an E-field emitted by one or more antenna 591 in filament bundle 592.

(5) For example, in another mode of operation, the controller 580 (and/or the controller 155) provides for oxidant such as air that enters the annular gap between electrode zones 582-585 and 533 to be ionized to produce activated oxidant particles such as electrically charged particles and/or radicals O₃, NOx, OH⁻ etc., that are launched into combustion chamber 528 by Lorentz thrust forces and/or by fuel pressure upon opening of valve 584 and/or by combustion and thermal expansion of combustion gases produced upon fuel flow.

These control features provide much greater air utilization efficiency than can be provided by direct injection (DI) of diesel fuel for combustion induced by hot compressed air and allow very rapid adaptive adjustments of initiation and completion of combustion with greatly varying fuels particularly including mixtures of fuel feedstocks and thermochemical regeneration (TCR) constituents.

In some implementations of the disclosed technology, exemplary systems can utilize auxiliary renewable, off-peak electricity or some other source of electricity to initially convert a suitable fuel such as renewable methane or natural gas into carbon and pressurized hydrogen as summarized by Equations 1 or 2 by application of electrical inductive and/or resistive heating including voltage across a proton membrane to pressurize a hydrogen accumulator such as 272H of FIG. 2C. After sufficient pressurization of 272H and storage of hot banked carbon at a suitable temperature such as 1000° C. in accumulators such as 256H, the engine 132 of the host vehicle or the ICE of a stationary application is started and auxiliary power is turned off. Electricity can be provided by operation of the carbon, carbon monoxide, and/or hydrogen fuel cells in zones 100, 180, 400Z, or 190 of FIG. 1D.

Using the disclosed methods and systems, high efficiency engine operation on directly injected hot hydrogen after TDC is provided by injector(s) 166 and Tier 4 emissions limitations can be accomplished. Hot carbon banking can be continued, e.g., including preheating with H1, H2 and/or H3 and/from renewable energy or regenerative suspension energy recovery (e.g., spring and/or shock absorber) or driveline deceleration energy such as provided by vehicular applications and/or by combustion of fuel with oxygen or air. Production of hot high pressure hydrogen can be continued by such carbon production along with optional galvanic pressurization.

Such operations can be implemented at selected times to store surplus or low cost energy and to provide rapid start-up. Exemplary applications, e.g., such as emergency vehicles and UPS systems, can operate efficiently and readily meet quick-start and/or widely varying transient operating conditions.

In some implementations of the discloses systems, hydrocarbon substances such as methane are dissociated to carbon and hydrogen, where the dissociated carbon is produced as mostly catalytic and/or epitaxially specialized self-organized carbon structures. Amorphous and other allotropic forms of carbon can be deposited and cyclically removed by oxidation and/or regenerative methanization using some of the hydrogen that has been returned from the cathode accumulator 260 and/or 272.

At selected times, typically in a lower frequency cycle, the anode is cleaned to recover the specialized self-organized carbon structures such as whiskers, nanotubes, and other architectural constructs. Carbon catalysts are of special interest in this regard such as production of carbon catalysts for hydrogen generation from feedstocks such as organic and inorganic wastes such as various forms and derivatives of cellulose, food wastes, iron, aluminum, magnesium etc., and waste or otherwise contaminated water.

In other applications carbon produced and stored within accumulator 256 is utilized to convert heat H1, H2, and/or H3 that is ordinarily wasted in endothermic production of highly valuable fuel and pressure potential energy, e.g., as summarized by Equation 8.

C+H₂O+HEAT₈→CO+H₂ Equation 8

In this pressurizing process solid carbon is converted to gaseous carbon monoxide as shown. Other oxygen donors including ethers, esters and alcohols such as ethanol, butanol, or methanol (e.g., shown in the Equations 7A-7F) provide similarly valuable pressure and chemical potential energy. Illustratively, solid and liquid reactants produce five moles of self-pressurizing hydrogen and carbon monoxide fuel gas. Some or all of the hydrogen can be separated and further pressurized by an exemplary systems such as the system 200 of FIG. 2A. Equation 9 summarizes the process.

C+CH₃OH+H₂O+HEAT₉→2CO+3H₂ Equation 9

Substantially increased fuel energy delivery rates can be provided at selected times. Illustratively, at times that processes such as Equations 5, 7, and/or 8 are utilized to contribute pressure and fuel values for operation of a furnace and/or engine (e.g., such as the engine 132), the fuel energy rate can be 200% or greater than the rate provided by the original feedstock (e.g., such as methane). This is particularly beneficial for supporting a combined-heat- and power (CHP) or cogeneration system with a large turn-down ratio and/or co-production of easily stored products and liquid fuels, e.g., such as urea, DME, DEE, and/or fuel alcohols and/or production of specialized allotropes of carbon.

Other embodiments of specialized allotropes of carbon allow improvements in organic photovoltaic devices (OPVs) and inorganic photovoltaic devices including carbon nanotubes such as transparent electrodes and/or multiple junction systems for applications that range from large scale photovoltaic films or panels to minute instrumentation for measurement and/or nodal wireless interrogation applications for reporting and/or energy harvesting of pressure, temperature, and radiant energy. Applications include carbon nanotubes as transparent electrodes and in conjugated polymers that incorporate carbon nanotubes (CNTs) to provide high electrical and/or thermal conductivity along the longitudinal tube axis. AC or DC plasma production and transfer of energy in accumulator region 256 can provide high value forms of specialized carbon. Illustratively, for example, arc-assisted dissociation of a carbon donor (e.g., such as methane) along an electrode (e.g., such as the electrode 257) can produce optically transparent CNT films. Excellent thermal and electrical conductivity, radiation transparency from infrared (IR) to ultraviolet (UV) single wall carbon nanotubes (SWCNTs) have a work function of 4.8 to 4.9 electron volts (eV) for high efficiency hole collection as a photovoltaic system.

Another embodiment utilizes single and/or multiwall carbon nanotubes (MWCNTs) as colloidal or suspended photovoltaic devices in water or waste water to produce hydrogen. The natural hydrophobicity of such structures requires development of hydrophilic surfaces such as may be provided by conversion of some or all of the surfaces of the carbon nanotubes to form carboxylic acid groups or thin coatings by materials such as titanium dioxide and/or other modifications to provide negatively charged surfaces.

### EXAMPLES

The following examples are illustrative of several embodiments of the present technology. Other exemplary embodiments of the present technology may be presented prior to the following listed examples, or after the following listed examples.

In an example of the present technology (example 1), a method for converting a fuels into energy or specialized fuel includes dissociating, in a reactor, a fuel to produce hot carbon and hydrogen, the hot carbon having a temperature state in a range of 700° C. to 1500° C., in which the dissociating includes providing one or both of heat and electric current to produce the hot carbon and the hydrogen; and removing the hot carbon and the hydrogen from the reactor, the removing including depositing the hot carbon to a chamber, in which the hot carbon includes an increased chemical potential energy and is capable of storing energy from an external source.

Example 2 includes the method of example 1, further including supplying an oxygen- and hydrogen-containing reactant to contact the hot carbon to produce carbon monoxide (CO) and hydrogen (H₂); and obtaining the produced CO and H₂, in which, after the supplying the steam, remaining deposited carbon forms a durable carbon-based good or product.

Example 3 includes the method of example 2, in which the supplying the steam occurs in the chamber.

Example 4 includes the method of example 2, in which the oxygen- and hydrogen-containing reactant includes at least one of steam, alcohol, or air.

Example 5 includes the method of example 2, in which the dissociating includes an endothermic conversion of the fuel to the hot carbon and hydrogen, and the supplying includes exothermic reaction to produce the CO and H₂.

Example 6 includes the method of example 1, in which the dissociating includes applying an electrical potential on one or more electrodes in the reactor to provide the electric current or to generate the heat to dissociate the fuel into the hot carbon and the hydrogen.

Example 7 includes the method of example 6, in which the electrodes are formed of a material including at least one of a metallic alloy, graphite, silicon carbide, or molybdenum disilicide.

Example 8 includes the method of example 1, further including pressurizing the produced hydrogen using a galvanic cell with a proton membrane.

Example 9 includes the method of example 1, in which the removing includes endothermic precipitation of the hot carbon into the chamber.

Example 10 includes the method of example 1, further including storing energy from a regenerative process using the hot carbon.

Example 11 includes the method of example 10, further including supplying the stored energy to the reactor to provide the heat to produce the hot carbon and the hydrogen.

Example 12 includes the method of example 10, in which the regenerative process includes braking or absorbing shock in a vehicle application.

Example 13 includes the method of example 1, in which the removing the hot carbon includes depositing the hot carbon in the chamber on a substrate formed of a material including at least one of graphene, nickel, mica, silicon carbide, a ceramic material, or carbon with a silicon nitride coating or a boron nitride coating.

Example 14 includes the method of example 13, in which the deposited hot carbon is formed as amorphous carbon on the substrate.

Example 15 includes the method of example 13, in which the substrate includes one or more catalysts to initiate formation of a carbon allotrope from the deposited hot carbon, the formed carbon allotrope including at least one of a fullerene, graphene, graphite, diamond, carbon nanotube, carbon nanofiber, or carbon nanowhisker.

Example 16 includes the method of example 15, in which the one or more catalysts includes at least one of carbon nanotubes, carbon nanofoam, nickel, iron, tungsten, molybdenum, niobium, vanadium, copper, copper-based alloy, or one or more intermetallics, carbides, nitrides, or cermet compounds.

Example 17 includes the method of example 1, further including using the hot carbon as a fuel and air as an oxidant in a fuel cell, and producing, in the fuel cell, one or more oxides of carbon and one or more nitrogenous substances.

Example 18 includes the method of example 17, further including during the producing, separating the oxidant from nitrogen in the fuel cell.

Example 19 includes the method of example 17, in which the oxides of carbon include at least one of carbon monoxide or carbon dioxide, and the nitrogenous substances include at least one of ammonia or urea.

Example 20 includes the method of example 1, further including extracting electrical energy from the hot carbon as a fuel in a fuel cell.

Example 21 includes the method of example 20, in which the removing the hot carbon includes depositing the hot carbon on or proximate an electrode of the fuel cell.

Example 22 includes the method of example 21, in which the hot carbon is deposited on or proximate to an anode of a composite fuel cell assembly including the anode, a cathode, and a proton transport membrane between the anode and the cathode to separate ionized hydrogen.

In another example of the present technology (example 23), a system for converting a fuels into energy or specialized fuel includes a reactor to receive a feedstock fuel and dissociate the fuel to carbon constituents and hydrogen by applying one or both of heat and electric current, the carbon constituents including hot carbon having a temperature state in a range of 700° C. to 1500° C. and having an increased chemical potential energy such that it is capable of storing external energy; and a chamber to receive the hot carbon, in which the chamber is electrically or thermally insulated and structured to include a substrate where the hot carbon is deposited.

Example 24 includes the system of example 23, in which the is structured to include one or more electrodes to apply an electrical potential that provides the electric current or generates the heat to dissociate the fuel.

Example 25 includes the system of example 24, in which the electrodes are formed of a material including at least one of a metallic alloy, graphite, silicon carbide, or molybdenum disilicide.

Example 26 includes the system of example 23, in which the deposited hot carbon in the chamber is reacted with an oxygen- and hydrogen-containing reactant to produce a carbon oxide and additional hydrogen.

Example 27 includes the system of example 26, in which the carbon oxide includes carbon monoxide.

Example 28 includes the system of example 26, in which the oxygen- and hydrogen-containing reactant includes at least one of steam, alcohol, or air.

Example 29 includes the system of example 26, further including an engine to receive and utilize one or both of the produced carbon oxide and hydrogen as fuel or as reactants in reactions within the engine.

Example 30 includes the system of example 26, further including a fuel cell to receive and utilize one or both of the produced carbon oxide and hydrogen as fuel or as reactants in reactions within the fuel cell to extract electrical energy to produce electricity.

Example 31 includes the system of example 23, further including a fuel cell to receive and use the hot carbon as a fuel and air as an oxidant to (i) produce one or more oxides of carbon and one or more nitrogenous substances, or (ii) extract electrical energy from the hot carbon.

Example 32 includes the system of example 31, in which the one or more oxides of carbon produced by the fuel cell include at least one of carbon monoxide or carbon dioxide, and the one or more nitrogenous substances produced by the fuel cell include at least one of ammonia or urea.

Exemplary Implementations

In some implementations, for example, carbon can be removed from a fuel and deposited in a hot state (700-1500° C. carbon temp), in which the carbon is removed from the fuel by endothermic precipitation, and in which the hot carbon can then be reacted with steam to create CO and H₂. The hot carbon may also be used for producing durable carbon for goods, for example.

In some implementations, hot banked carbon is used in lieu of batteries to store energy from regenerative processes such as regenerative braking or shock absorbers. Electricity from regenerative processes can be used to drive the system. Electrodes (silicon carbide) are electrified with the electricity which dissociates CH₄ into hydrogen and carbon. The hydrogen is then fed to a proton membrane that pressurizes the hydrogen for use in an engine, for example. In other embodiments, ships could use electricity from the port to power the dissociation step. Hot banked carbon energy storage may be preferred over batteries based on efficiency and environmental impact considerations. A hot banked carbon fuel cell has an efficiency of 60 to 85% compared to an engine driven alternator and charging circuit with a battery of ˜5-18%.

Also in some implementations, for example, the disclosed methods and systems produce hot banked nitrogen in a process for banking energy. Nitrogen is taken from the air and combined with hydrogen to make ammonia or urea. Banking comes from the formation of a compound (e.g., ammonia or urea or another nitrogeneous compound). Pressurized hydrogen and nitrogen combine to form ammonia or various nitrogenous compounds. In some examples the nitrogen can come from rich vehicle exhaust.

Various embodiments of the systems and methods of the disclosed technology can be utilized to: (1) produce and thermally isolate hot banked carbon to store thermal and chemical potential energy; (2) utilize purified hot carbon to make valuable carbon allotropes, e.g., such as carbon fiber, fuzzy carbon fiber, various forms of graphene and architectural constructs, nanotube electro-optics, nano-spaced graphene membranes for molecular sieves, adsorptive processing, filtration and/or galvanic pressurization; (3) utilize the hot carbon directly as a hot fuel in a fuel cell that uses air as an oxidant and produces CO or CO₂ feedstocks and separated nitrogen-rich feed stock for making NH₃ and other nitrogenous substances, e.g., such as CH₄N₂O; (4) utilize the co-produced hot hydrogen and/or hot carbon as heat sources to preheat feedstocks such as CₓH_{y} for thermal and/or electrically induced dissociation; (5) utilize the elevated temperature carbon to heat electrodes and an ion transport membrane for efficient operation of a carbon-fueled fuel cell to produce electricity that can be at an improved efficiency, e.g., as compared to a heat engine or hydrogen fuel cell; (6) utilize the coproduced hydrogen to fuel a heat engine that cleans the air and utilize H-1, H-2 and/or H-3 from the engine to drive an endothermic reaction to produce carbon and hydrogen; and (7) utilize the separated and purified CO and/or CO₂ product(s) from the hot carbon fuel cell to produce fuels, e.g., such as alcohols, ethers, formic and other acids, along with other values such as fluid fuels that can be transported by conventional pipelines and stored in tanks originally designed for gasoline, diesel fuel, liquefied petroleum gases or compressed natural gas or hydrogen, for example, such as the following reactions:

CO+2H₂→CH₃OH, CO₂+3H₂→CH₃OH+H₂O,

CO+2H₂+N₂→CH₄N₂O, CO₂+H₂→CHOOH, and/or

N₂+3H₂→2NH₃.

While this patent document contains many specifics, these should not be construed as limitations on the scope of any disclosed methods or of what may be claimed, but rather as descriptions of features that may be specific to particular embodiments of particular disclosed methods. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

I/We claim:

1. A method for converting a fuel into energy or specialized fuel, comprising:
in a reactor, dissociating a fuel to produce hot carbon and hydrogen, the hot carbon having a temperature state in a range of 700° C. to 1500° C., wherein the dissociating includes providing one or both of heat and electric current to produce the hot carbon and the hydrogen; and
removing the hot carbon and the hydrogen from the reactor, the removing including depositing the hot carbon to a chamber,
wherein the hot carbon includes an increased chemical potential energy and is capable of storing energy from an external source.

2. The method of claim 1, further comprising:
supplying an oxygen- and hydrogen-containing reactant to contact the hot carbon to produce carbon monoxide (CO) and hydrogen (H₂); and
obtaining the produced CO and H₂,
wherein, after the supplying the steam, remaining deposited carbon forms a durable carbon-based good or product.

3. The method of claim 2, wherein the supplying the steam occurs in the chamber.

4. The method of claim 2, wherein the oxygen- and hydrogen-containing reactant includes at least one of steam, alcohol, or air.

5. The method of claim 2, wherein the dissociating includes an endothermic conversion of the fuel to the hot carbon and hydrogen, and the supplying includes exothermic reaction to produce the CO and H₂.

6. The method of claim 1, wherein the dissociating includes applying an electrical potential on one or more electrodes in the reactor to provide the electric current or to generate the heat to dissociate the fuel into the hot carbon and the hydrogen.

7. The method of claim 6, wherein the electrodes are formed of a material including at least one of a metallic alloy, graphite, silicon carbide, or molybdenum disilicide.

8. The method of claim 1, further comprising:
pressurizing the produced hydrogen using a galvanic cell with a proton membrane.

9. The method of claim 1, wherein the removing includes endothermic precipitation of the hot carbon into the chamber.

10. The method of claim 1, further comprising:
storing energy from a regenerative process using the hot carbon.

11. The method of claim 10, further comprising:
supplying the stored energy to the reactor to provide the heat to produce the hot carbon and the hydrogen.

12. The method of claim 10, wherein the regenerative process includes braking or absorbing shock in a vehicle application.

13. The method of claim 1, wherein the removing the hot carbon includes depositing the hot carbon in the chamber on a substrate formed of a material including at least one of graphene, nickel, mica, silicon carbide, a ceramic material, or carbon with a silicon nitride coating or a boron nitride coating.

14. The method of claim 13, wherein the deposited hot carbon is formed as amorphous carbon on the substrate.

15. The method of claim 13, wherein the substrate includes one or more catalysts to initiate formation of a carbon allotrope from the deposited hot carbon, the formed carbon allotrope including at least one of a fullerene, graphene, graphite, diamond, carbon nanotube, carbon nanofiber, or carbon nanowhisker.

16. The method of claim 15, wherein the one or more catalysts includes at least one of carbon nanotubes, carbon nanofoam, nickel, iron, tungsten, molybdenum, niobium, vanadium, copper, copper-based alloy, or one or more intermetallics, carbides, nitrides, or cermet compounds.

17. The method of claim 1, further comprising:
using the hot carbon as a fuel and air as an oxidant in a fuel cell, and
producing, in the fuel cell, one or more oxides of carbon and one or more nitrogenous substances.

18. The method of claim 17, further comprising:
during the producing, separating the oxidant from nitrogen in the fuel cell.

19. The method of claim 17, wherein the oxides of carbon include at least one of carbon monoxide or carbon dioxide, and the nitrogenous substances include at least one of ammonia or urea.

20. The method of claim 1, further comprising:
extracting electrical energy from the hot carbon as a fuel in a fuel cell.

21. The method of claim 20, wherein the removing the hot carbon includes depositing the hot carbon on or proximate an electrode of the fuel cell.

22. The method of claim 21, wherein the hot carbon is deposited on or proximate to an anode of a composite fuel cell assembly including the anode, a cathode, and a proton transport membrane between the anode and the cathode to separate ionized hydrogen.

23. A system for converting a fuel into energy or specialized fuel, comprising:
a reactor to receive a feedstock fuel and dissociate the feedstock fuel to carbon constituents and hydrogen by applying one or both of heat and electric current, the carbon constituents including hot carbon having a temperature state in a range of 700° C. to 1500° C. and having an increased chemical potential energy such that it is capable of storing external energy; and
a chamber to receive the hot carbon, wherein the chamber is electrically or thermally insulated and structured to include a substrate where the hot carbon is deposited.

24. The system of claim 23, wherein the reactor is structured to include one or more electrodes to apply an electrical potential that provides the electric current or generates the heat to dissociate the fuel.

25. The system of claim 24, wherein the electrodes are formed of a material including at least one of a metallic alloy, graphite, silicon carbide, or molybdenum disilicide.

26. The system of claim 23, wherein the deposited hot carbon in the chamber is reacted with an oxygen- and hydrogen-containing reactant to produce a carbon oxide and additional hydrogen.

27. The system of claim 26, wherein the carbon oxide includes carbon monoxide.

28. The system of claim 26, wherein the oxygen- and hydrogen-containing reactant includes at least one of steam, alcohol, or air.

29. The system of claim 26, further comprising:
an engine to receive and utilize one or both of the produced carbon oxide and additional hydrogen as fuel or as reactants in reactions within the engine.

30. The system of claim 26, further comprising:
a fuel cell to receive and utilize one or both of the produced carbon oxide and additional hydrogen as fuel or as reactants in reactions within the fuel cell to extract electrical energy to produce electricity.

31. The system of claim 23, further comprising:
a fuel cell to receive and use the hot carbon as a fuel and air as an oxidant to (i) produce one or more oxides of carbon and one or more nitrogenous substances, or (ii) extract electrical energy from the hot carbon.

32. The system of claim 31, wherein the one or more oxides of carbon produced by the fuel cell include at least one of carbon monoxide or carbon dioxide, and the one or more nitrogenous substances produced by the fuel cell include at least one of ammonia or urea.
